(19) United States
(12) Patent Application Publication
(10) Pub. No.: US 2017/0235032 A1
(43) Pub. Date: Aug. 17, 2017

(54) OPTICAL FILM

(71) Applicant: Sumitomo Chemical Company, Limited, Tokyo (JP)

(72) Inventor: Katsuaki MIYAZAKI, Osaka (JP)

(21) Appl. No.: 15/429,698

(22) Filed: Feb. 10, 2017

(30) Foreign Application Priority Data
Feb. 12, 2016 (JP) 2016-024401

(51) Int. Cl. G02B 5/20; G02B 5/30; C09J 11/06; C09J 7/02; C09J 133/08

(52) U.S. Cl. CPC G02B 5/208; C09J 7/0217; C09J 133/08; C09J 11/06; G02B 5/3033; C09J 2205/114; C09J 2433/00

(57) ABSTRACT

Provided is an optical film which has high selective absorbability to short-wavelength visible light having wavelengths around 420 nm and hence a high blue-light cutting function and can impart better display characteristics when used for a display device. The optical film satisfies the following two formulae: (1) A(420)≧1 and (2) A(450)/A(420)≦0.3, wherein A(420) represents an absorbance of the optical film at a wavelength of 420 nm and A(450) represents an absorbance of the optical film at a wavelength of 450 nm.

### BACKGROUND OF THE INVENTION

Field of the Invention

The present invention relates to an optical film and a display device containing the optical film.

Description of the Related Art

Optical films such as polarizing plates and retardation films are used for flat panel display devices (FPD) such as organic EL display devices and liquid crystal display devices. In these optical films, measures are taken, for example, addition of a UV absorber to a protective film of a polarizing plate to prevent deterioration caused by UV rays (JP-A-2006-308936)

### SUMMARY OF THE INVENTION

In recent years, displays have problems concerning eyestrain and deterioration in eyesight when viewing displays for a long time and are therefore desired to have a blue-light cutting function of cutting short-wavelength visible light to solve the above problem. These display devices are, on the other hand, desired to have resistance to the absorption of blue light which is light having wavelengths around 450 nm for better color expression. This is the reason why an optical film capable of selectively absorbing light having wavelengths around 420 nm is needed.

It is an object of the present invention to provide an optical film which has high selective absorbability to short-wavelength visible light having wavelengths around 420 nm and hence a high blue-light cutting function and can impart better display characteristics when used for a display device.

The present invention provides the following preferred aspects 1 to 15.

[1] An optical film satisfying the formulae (1) and (2):

A(420)≧1 (1)

A(450)/A(420)≦0.3 (2)

wherein A(420) represents an absorbance of the optical film at a wavelength of 420 nm and A(450) represents an absorbance of the optical film at a wavelength of 450 nm.

[2] The optical film according to the above [1], including at least one pressure-sensitive adhesive layer.

[3] The optical film according to the above [1] or [2], wherein the at least one pressure-sensitive adhesive layer exist in the interior structure of the optical film or exist on the outermost surface of the optical film.

[4] The optical film according to the above [2] or [3], wherein the pressure-sensitive adhesive layer includes a pressure-sensitive adhesive composition containing:

(A) an acrylic resin;

(B) a crosslinking agent; and

(C) a light-selective absorption compound satisfying the formula (3):

ε(450)/ε(420)≦0.3 (3)

wherein ε(450) represents a gram absorption coefficient at a wavelength of 450 nm and ε(420) represents a gram absorption coefficient at a wavelength of 420 nm.

[5] The optical film according to the above [4], wherein the pressure-sensitive adhesive composition contains:

(A) an acrylic resin which has a weight average molecular weight of 500000 to 2000000 and is a copolymer containing, as structural components:

(A-1) 50 to 99.9% by mass of a (meth)acrylate monomer represented by the formula (A-1):

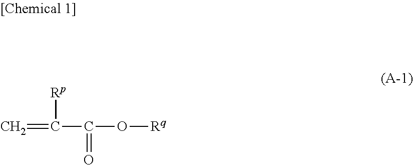

wherein R^{p} represents a hydrogen atom or a methyl group, R^{q} represents an alkyl group having 1 to 20 carbon atoms or an aralkyl group in which hydrogen atoms constituting the alkyl group or the aralkyl group are optionally substituted with —O—(C₂H₄O)ₙ—R^{r} (n represents an integer from 0 to 4 and R^{r} represents an alkyl group having 1 to 12 carbon atoms or an aryl group having 1 to 12 carbon atoms); and

(A-2) 0.1 to 50% by mass of an unsaturated monomer having a polar functional group, based on the total solid content of the acrylic resin; and

(B) 0.01 to 10 parts by mass of a crosslinking agent based on 100 parts by mass of the acrylic resin.

[6] The optical film according to the above [4] or [5], the optical film including 0.01 to 10 parts by mass of the light-selective absorption compound based on 100 parts by mass of the acrylic resin.

[7] The optical film according to any one of the above [1] to [6], including a light-selective absorption compound satisfying the formulae (3), (4), and (5):

ε(450)/ε(420)≦0.3 (3)

λmax≦430 nm (4)

ε(420)≧20 (5)

wherein ε(450) represents a gram absorption coefficient at a wavelength of 450 nm, ε(420) represents a gram absorption coefficient at a wavelength of 420 nm, and λmax represents the maximum absorption wavelength of the light-selective absorption compound.

[8] The optical film according to any one of the above [4] to [7], wherein;

the light-selective absorption compound is a compound selected from the group consisting of a compound having a dimethine skeleton, an azo compound, and a compound having a pyrazolone skeleton.

[9] The optical film according to any one of the above [4] to [8], wherein the light-selective absorption compound is a compound having a dimethine skeleton with at least one electron-attracting group on one side thereof and at least one electron-donating group on the other side thereof.

[10] The optical film according to any one of the above [4] to [9], wherein

the light-selective absorption compound includes at least one compound selected from the group consisting of;

a compound represented by the formula (I):

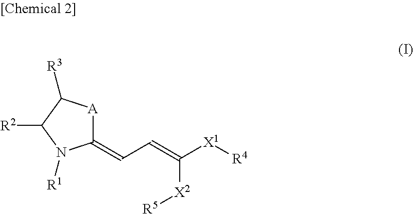

wherein R¹ represents a hydrogen atom or an alkyl group having 1 to 10 carbon atoms, wherein when the alkyl group has at least one methylene group, at least one of the methylene group is optionally substituted with an oxygen atom or a sulfur atom; R² and R³ each independently represent a hydrogen atom or an alkyl group having 1 to 12 carbon atoms; R⁴ and R⁵ each independently represent an alkyl group having 1 to 50 carbon atoms or an alkyl group having 3 to 50 carbon atoms and at least one methylene group, in which at least one of the methylene group is substituted with an oxygen atom, a carbon atom on the alkyl group is optionally bonded with a substituent, and R⁴ and R⁵ may be combined to form a ring structure, wherein when the ring structure formed by R⁴ and R⁵ has at least one methylene group, at least one of the methylene group is optionally substituted with —CO—, —NR⁶—, —NCH₂COOR⁶⁻¹—, —O—, —CS—, or —COO—, wherein R⁶ and R⁶⁻¹ each independently represent an alkyl group having 1 to 12 carbon atoms;

A represents a methylene group, a secondary amino group, an oxygen atom, or a sulfur atom; and

X¹ and X² each independently represent —CO—, —COO—, —OCO—, —O—, —S—, —NR⁷—, —NR⁸CO—, or —CONR⁹—, wherein R⁷, R⁸, and R⁹ each independently represent a hydrogen atom, an alkyl group having 1 to 6 carbon atoms, or a phenyl group;

a compound represented by the formula (II):

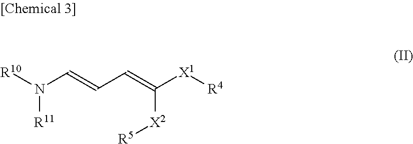

wherein R¹⁰ and R¹¹ each independently represent an alkyl group having 1 to 12 carbon atoms, an aralkyl group, an aryl group, or a heterocyclic group, wherein when the alkyl group has at least one methylene group, at least one of the methylene group is optionally substituted with an oxygen atom or a sulfur atom, the aralkyl group, the aryl group, and the heterocyclic group each optionally have a substituent, and R¹⁰ and R¹¹ may be combined to form a ring structure; and

R⁴, R⁵, X¹, and X² have the same meanings as those in the formula (I); and

a compound represented by the formula (III):

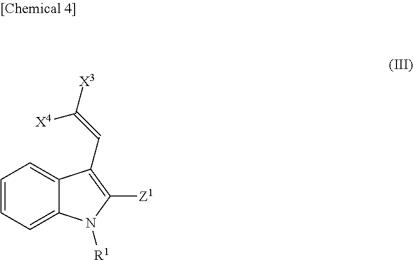

wherein Z¹ represents a hydrogen atom, an alkyl group having 1 to 10 carbon atoms, an aralkyl group, an aryl group, or a heterocyclic group, wherein when the alkyl group has at least one methylene group, at least one of the methylene group is optionally substituted with a secondary amino group, an oxygen atom, or a sulfur atom, and the aralkyl group, the aryl group, and the heterocyclic group each optionally have a substituent and X³ and X⁴ each independently represent an electron-attracting group;

R¹ has the same meaning as that in the formula (I).

[11] The optical film according to the above [10], wherein X¹ and X² in the formulae (I) and (II) are each independently selected from —CO—, —COO—, and —CONR⁹—.

[12] The optical film according to the above [10] or [11], wherein, in the formula (I), R² and R³ are each independently a hydrogen atom, and A is a methylene group or a sulfur atom.

[13] The optical film according to the above [10], wherein the compound represented by the formula (II) is a compound represented by the formula (II) in which R¹⁰ and R¹¹ are each independently an alkyl group having 1 to 10 carbon atoms or a compound represented by the formula (II-1):

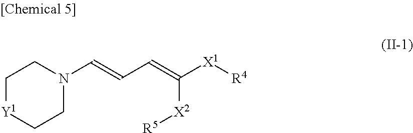

wherein Y¹ represents a methylene group or an oxygen atom; and

R⁴, R⁵, X¹, and X² have the same meanings as those in the formula (I).

[14] The optical film according to any one of the above [1] to [13], including at least one polarizing plate and satisfying the formulae (1-1) and (2-1):

Ap(420)≧1 (1-1)

Ap(450)/Ap(420)≦0.3 (2-1)

wherein Ap(420) represents an absorbance of the optical film at a wavelength of 420 nm in a transmission direction of the polarizing plate and Ap(450) represents an absorbance of the optical film at a wavelength of 450 nm in the transmission direction of the polarizing plate.

[15] The optical film according to any one of the above [1] to [14], including at least one retardation film.

[16] A display device including the optical film according to any one of the above [1] to [15].

The present invention can provide an optical film which has high selective absorbability to short-wavelength visible light having wavelengths around 420 nm and hence a high blue-light cutting function and can impart better display characteristics when used in a display device.

### DETAILED DESCRIPTION OF THE PREFERRED EMBODIMENTS

The embodiments of the present invention will be explained in detail. It is to be noted that the scope of the present invention is not limited to the embodiments explained here and may be variously modified without departing from the range of the spirit of the present invention.

The optical film of the present invention is an optical film satisfying the formulae (1) and (2):

A(420)≧1 (1)

A(450)/A(420)≦0.3 (2)

In the formulae (1) and (2), A(420) represents the absorbance of the optical film at a wavelength of 420 nm and A(450) represents the absorbance of the optical film at a wavelength of 450 nm. When the formulae (1) and (2) are satisfied, the optical film has high selective absorbability at wavelengths around 420 nm and hence a high blue-light cutting function and can therefore impart better display characteristics when it is incorporated into a display device. The term “blue light” in this description means light having a wavelength range from 380 to 450 nm.

The absorption at a wavelength of 420 nm is larger with increase in the value A(420). When this value is less than 1, absorption at a wavelength of 420 nm is low and it is therefore difficult to sufficiently secure high light-selective absorbability to short wavelength visible light having wavelengths around 420 nm. Therefore, the value of A(420) of the optical film of the present invention is preferably 2.0 or more, more preferably 2.5 or more, and even more preferably 3.0 or more. The value of A(420) is preferably 5.0 or less to avoid breed-out of the light-selective absorption compound with time from the layer containing the compound although no particular limitation is imposed on its upper limit.

The value of A(450)/A(420) indicates the ratio of the intensity of absorption at a wavelength of 450 nm to the intensity of absorption at a wavelength of 420 nm. Decrease in this value indicates the existence of specific absorption in a wavelength range around 420 nm. The optical film is more improved in light-selective absorbability with decrease in this value. When this value exceeds 0.3, light having wavelengths around 420 nm can be insufficiently absorbed and also, blue light having wavelengths around 450 nm which is emitted from a display device such as an organic EL device is resultantly absorbed. Therefore, when this optical film is used for a display device, better color expression can be obtained with difficulty and the display characteristics of the display device tends to be deteriorated. Therefore, the value of A(450)/A(420) of the optical film of the present invention is preferably 0.25 or less, more preferably 0.20 or less, even more preferably 0.15 or less, even more preferably 0.10 or less, and most preferably 0.08 or less. The value of A(450)/A(420) is preferably 0.001 or more from the viewpoint of the light fastness of the optical film though no particular limitation is imposed on its lower limit. The value of A(450)/A(420) in a preferred embodiment of the present invention is 0.001 to 0.08.

Examples of the optical film of the present invention satisfying the formulae (1) and (2) include pressure-sensitive adhesive films (hereinafter described as pressure-sensitive adhesive layers) made from pressure-sensitive adhesives, retardation films, polarizing films (hereinafter described as polarizing plates), and protection films. Also, the optical film of the present invention may be a laminated optical film containing at least one optical film selected from the group consisting of pressure-sensitive adhesive layers, retardation films, and polarizing plates.

The absorption characteristics of the optical film which satisfies the formulae (1) and (2) can be controlled by formulating a compound having selective absorbability to a wavelength range around 420 nm. Examples of the compound having selective absorbability to a wavelength range around 420 nm include compounds satisfying the formula (3).

ε(450)/ε(420)≦0.3 (3)

In the formula (3), ε(420) represents a gram absorption coefficient at a wavelength of 420 nm and ε(450) represents a gram absorption coefficient at a wavelength of 450 nm, wherein the unit of the gram absorption coefficient is expressed by L/(g·cm).

The value of ε(450)/ε(420) indicates the ratio of the intensity of absorption at a wavelength of 450 nm to the intensity of absorption at a wavelength of 420 nm. Decrease in this value indicates the existence of specific absorption in a wavelength range around 420 nm. High selective absorbability to a wavelength range around 420 nm can be imparted to the optical film by formulating the compound having such absorption characteristics in the optical film. Accordingly, the value of ε(450)/ε(420) is preferably 0.25 or less, more preferably 0.20 or less, even more preferably 0.15 or less, even more preferably 0.10 or less, and most preferably 0.05 or less. The value of ε(450)/ε(420) is preferably 0.001 or more from the viewpoint of the light fastness of the optical film though no particular limitation is imposed on its lower limit. The value of ε(450)/ε(420) in a preferred embodiment of the present invention is 0.002 to 0.015.

Therefore, in a preferred embodiment of the present invention, the optical film preferably includes a light-selective absorption compound satisfying the formula (3). In the present invention, the compound having absorption characteristics satisfying the formula (3) is called “light-selective absorption compound” as the compound having high selective absorbability to a wavelength range around 420 nm.

### Light-Selective Absorption Compound

In the present invention, the light-selective absorption compound satisfies, besides the formula (3), the formulae (4) and (5).

λmax≦430 nm (4)

ε(420)≧20 (5)

In the formula (4), λmax represents the maximum absorption wavelength of the light-selective absorption compound and in the formula (5), ε(420) represents a gram absorption coefficient at a wavelength of 420 nm. The unit of the gram absorption coefficient is expressed by L/(g·cm).

When the formulae (4) and (5) are satisfied, the light-selective absorption compound may be said to be a compound which has a maximum absorption at a wavelength shorter than 430 nm and also, has strong absorption at wavelengths around 420 nm. When such a light-selective absorption compound is contained, an optical film having a high blue-light cutting function is obtained without any adverse influence on display characteristics. Also, this is advantageous in the point that the compound can produce a high absorption effect in a small amount. In the present invention, the maximum absorption wavelength λmax of the light-selective absorption compound is more preferably 420 nm or less and even more preferably 415 nm or less. Also, the maximum absorption wavelength λmax of the light-selective absorption compound preferably exists at a wavelength of 380 nm or more and more preferably at a wavelength of 390 nm or more from the viewpoint of light-selective absorptivity. The value of ε(420) is preferably 20 or more, more preferably 40 or more, even more preferably 50 or more, and most preferably 70 or more. The value of ε(420) is usually 500 or less although no particular limitation is imposed on its upper limit.

The light-selective absorption compound which can be formulated in the optical film of the present invention is preferably a compound selected from the group consisting of compounds having a dimethine skeleton, azo compounds, and compounds having a pyrazolone skeleton from the viewpoint of light-selective absorbability and easiness of addition to an optical film. Among these compounds, a compound having a dimethine skeleton is preferable and a compound having a dimethine skeleton with at least one electron-attracting group at one end thereof and with at least one electron donating group at the other end is more preferable as the group combined to the dimethine skeleton. A compound having such a structure is desirable because the position of the maximum absorption wavelength can be controlled and light having wavelengths around 420 nm can be selectively absorbed without reducing the gram absorption coefficient of the compound by a combination of the electron donating group and electron-attracting group.

The optical film of the present invention preferably contains, as the light-selective absorption compound, at least one compound selected from the group consisting of:

Compounds represented by the formula (I):

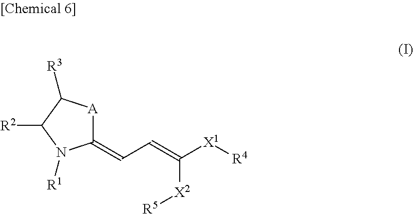

In the formula (I), R¹ represents a hydrogen atom or an alkyl group having 1 to 10 carbon atoms, wherein when the alkyl group has at least one methylene group, at least one of the methylene group is optionally substituted with an oxygen atom or a sulfur atom, R² and R³ each independently represent a hydrogen atom or an alkyl group having 1 to 12 carbon atoms, R⁴ and R⁵ each independently represent an alkyl group having 1 to 50 carbon atoms or an alkyl group having 3 to 50 carbon atoms and at least one methylene group in which at least one of the methylene group is substituted with an oxygen atom, a carbon atom on the alkyl group may be bonded with a substituent, and R⁴ and R⁵ may be combined to forma ring structure, wherein when the ring structure formed by R⁴ and R⁵ has at least one methylene group, at least one of the methylene group is optionally substituted with —CO—, —NR⁶—, —NCH₂COOR⁶⁻¹—, —O—, —CS—, or —COO—, wherein R⁶ and R⁶⁻¹ each independently represent an alkyl group having 1 to 12 carbon atoms;

A represents a methylene group, a secondary amino group, an oxygen atom, or a sulfur atom; and

X¹ and X² each independently represent —CO—, —COO—, —OCO—, —O—, —S—, —NR⁷—, —NR⁸CO—, or —CONR⁹—, wherein R⁷, R⁸, and R⁹ each independently represent a hydrogen atom, an alkyl group having 1 to 6 carbon atoms, or a phenyl group;

compounds represented by the formula (II):

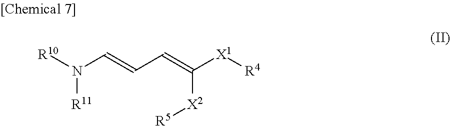

wherein R¹⁰ and R¹¹ each independently represent an alkyl group having 1 to 12 carbon atoms, an aralkyl group, an aryl group, or a heterocyclic group, wherein when the alkyl group has at least one methylene group, at least one of the methylene group is optionally substituted with an oxygen atom or a sulfur atom, wherein the aralkyl group, aryl group, and heterocyclic group may have a substituent, and R¹⁰ and R¹¹ may be combined to form a ring structure; and

R⁴, R⁵, X¹, and X² have the same meanings as those in the formula (I); and

compounds represented by the formula (III):

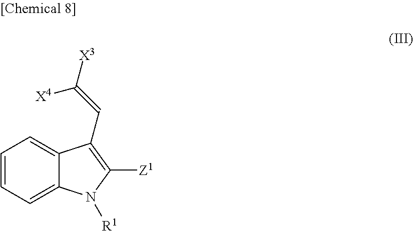

wherein Z¹ represents a hydrogen atom, an alkyl group having 1 to 10 carbon atoms, an aralkyl group, an aryl group, or a heterocyclic group, wherein when the alkyl group has at least one methylene group, at least one of the methylene group is optionally substituted with a secondary amino group, an oxygen atom, or a sulfur atom, wherein the aralkyl group, aryl group, and heterocyclic group may have a substituent and X³ and X⁴ each independently represent an electron-attracting group; and

R¹ has the same meaning as that in the formula (I).

### (Compounds Represented by the Formula (I))

In the formula (I), R¹ represents a hydrogen atom or an alkyl group having 1 to 10 carbon atoms. R¹ is an alkyl group having preferably 1 to 8 carbon atoms, more preferably having 1 to 5 carbon atoms, and even more preferably having 1 to 3 carbon atoms from the viewpoint of high light-selective absorbability. Here, when the alkyl group has at least one methylene group, at least one of the methylene group is optionally substituted with an oxygen atom or sulfur atom. Examples of the alkyl group include a methyl group, ethyl group, n-propyl group, isopropyl group, n-butyl group, tert-butyl group, n-hexyl group, n-octyl group, n-decyl group, methoxygroup, ethoxygroup, and isopropoxy group.

In the formula (I), R² and R³ each independently represent a hydrogen atom or an alkyl group having 1 to 12 carbon atoms. R² and R³ each independently preferably represent a hydrogen atom or an alkyl group having 1 to 10 carbon atoms, more preferably a hydrogen atom or an alkyl group having 1 to 8 carbon atoms, even more preferably a hydrogen atom or an alkyl group having 1 to 5 carbon atoms, particularly preferably a hydrogen atom or an alkyl group having 1 to 3 carbon atoms, and most preferably a hydrogen atom from the viewpoint of high light-selective absorbability.

In the formula (I), R⁴ and R⁵ each independently represent an alkyl group having 1 to 50 carbon atoms or an alkyl group having 3 to 50 carbon atoms and at least one methylene group wherein at least one of the methylene group is substituted with an oxygen atom. The alkyl group having 1 to 50 carbon atoms has preferably 2 to 40 carbon atoms, more preferably 3 to 35 carbon atoms, and even more preferably 4 to 30 carbon atoms from the viewpoint of affinity to the acrylic resin (A) which will be explained later and solubility in various organic solvents. Particularly, when R⁴ and R⁵ are each an alkyl group having 3 to 50 carbon atoms, R⁴ and R⁵ are each preferably a branched alkyl group having preferably 3 to 12 carbon atoms and more preferably 6 to 10 carbon atoms from the viewpoint of affinity to hydrophobic substances and solubility in hydrophobic solvents. Here, the branched alkyl group means an alkyl group in which at least one of the carbon atoms thereof is a tertiary carbon or quaternary carbon. Examples of the branched alkyl groups having 3 to 12 carbon atoms include alkyl groups having the following structures.

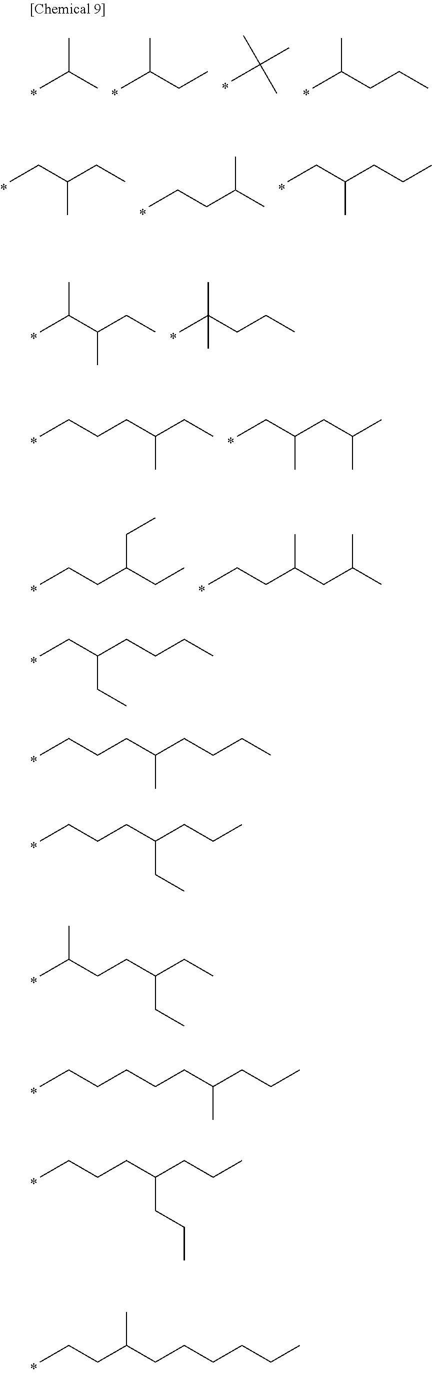

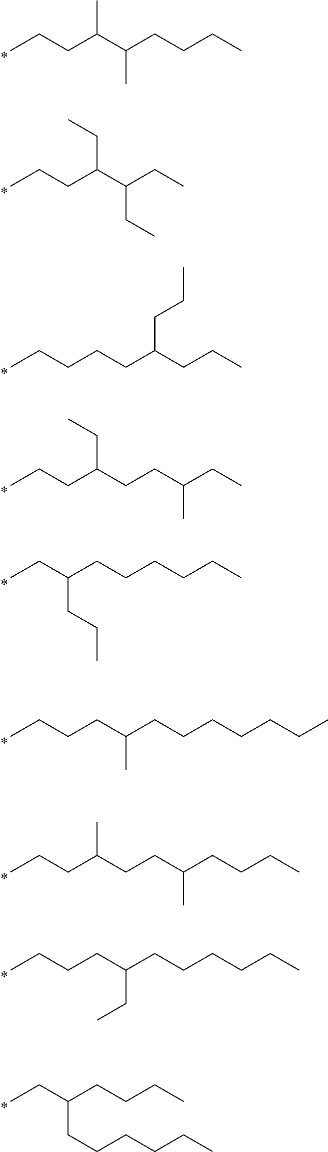

* represents a connecting group.

The alkyl group having 3 to 50 carbon atoms and at least one methylene group is an alkyl group having preferably 3 to 45, more preferably 3 to 40, even more preferably 4 to 35, and particularly preferably 5 to 30, and especially preferably 5 to 20 carbon atoms from the viewpoint of affinity to hydrophilic materials and hydrophobic materials, that is, amphiphilicity of the light-selective absorption compound. Here, in the alkyl group having 3 to 50 carbon atoms and at least one methylene group, at least one of these methylene groups is substituted with an oxygen atom and examples of the alkyl group include an ethoxy group, propoxy group, 2-methoxyethoxymethyl group, diethylene glycol group, triethylene glycol group, dipropylene glycol group, and tripropylene glycol group.

Also, a substituent may be bonded to a carbon atom on the alkyl group of R⁴ and R⁵. Examples of the substituent include a halogen atom, alkyl group having 1 to 6 carbon atoms, cyano group, nitro group, alkylsulfinyl group having 1 to 6 carbon atoms, alkylsulfonyl group having 1 to 6 carbon atoms, carboxyl group, fluoroalkyl group having 1 to 6 carbon atoms, alkoxy group having 1 to 6 carbon atoms, alkylthio group having 1 to 6 carbon atoms, N-alkylamino group having 1 to 6 carbon atoms, N,N-dialkylamino group having 2 to 12 carbon atoms, N-alkylsulfamoyl group having 1 to 6 carbon atoms, and N,N-dialkylsulfamoyl group having 2 to 12 carbon atoms.

Furthermore, R⁴ and R⁵ may be combined to form a ring structure. When the ring structure formed by R⁴ and R⁵ has at least one methylene group, at least one of the methylene group is optionally substituted with —CO—, —NR⁶—, —NCH₂COOR⁶⁻¹—, —O—, —CS—, or —COO—. Here, R⁶ and R⁶⁻¹ each independently represent an alkyl group having 1 to 12 carbon atoms.

In the formula (I), A represents a methylene group, a secondary amino group, an oxygen atom, or a sulfur atom and preferably represents a methylene group or a sulfur atom from the viewpoint of developing light selective absorptivity.

In the formula (I), X¹ and X² each independently represent —CO—, —COO—, —OCO—, —O—, —S—, —NR⁷—, NR⁸CO—, or —CONR⁹—. Here, R⁷, R⁸ and R⁹ each independently represent a hydrogen atom, an alkyl group having 1 to 6 carbon atoms, or a phenyl group. X¹ and X² are each independently preferably —CO—, —COO—, or —CONR⁹— and more preferably —CO— from the viewpoint of the light fastness of the compound represented by the formula (I) and solubility of the compound in organic solvents.

The compound represented by the formula (I) is preferably a compound represented by the formula (I) in which X¹ and X² are each independently —CO—, —COO—, or —CONR⁹— and more preferably a compound represented by the formula (I-1):

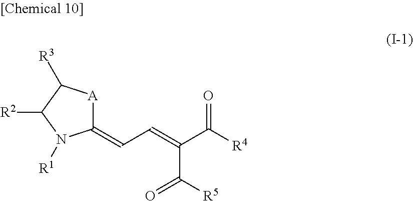

In the formula (I-1), R¹ to R⁵ and A have the same meanings as those in the formula (I). The compound represented by the formula (I-1) has excellent light fastness and particularly has excellent light-selective absorbability and is therefore preferable.

Also, a compound represented by formula (I) in which R² and R³ are each a hydrogen atom and A is a methylene group or a sulfur atom is preferable and a compound represented by formula (I-1) in which R² and R³ are each a hydrogen atom and A is a methylene group or a sulfur atom is more preferable.

Also, the compound represented by the formula (I) is more preferably a compound represented by the formula (I-2) or (I-3):

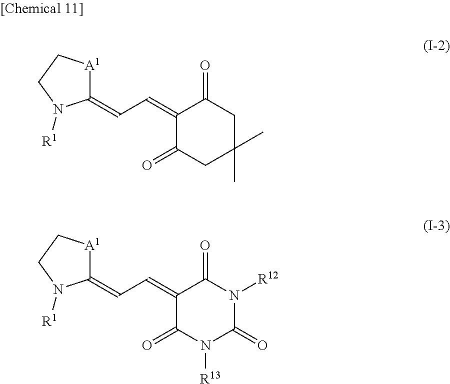

In the formulae (I-2) and (I-3), A¹ represents a methylene group or a sulfur atom, R¹² and R¹³ each independently represent an alkyl group having 1 to 6 carbon atoms, and R¹ has the same meaning as that in the formula (I). The compound represented by the formula (I-2) or (I-3) is particularly superior in light-selective absorptivity and is also superior in the viewpoint of economical productivity, which is preferable.

Examples of the compound represented by the formula (I) include the following compounds.

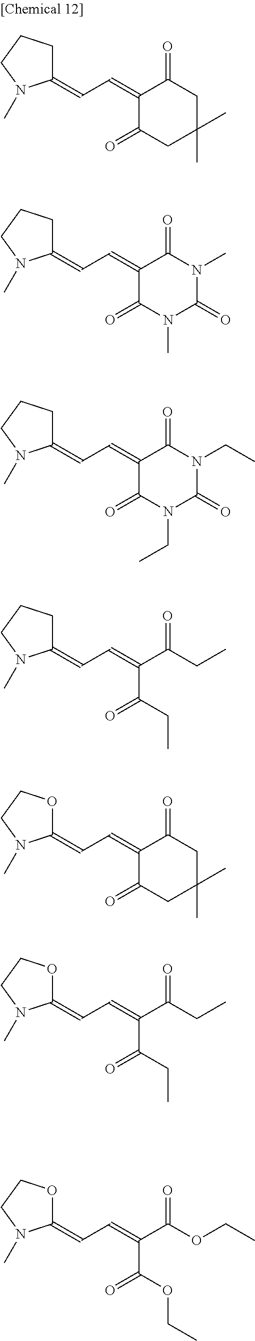

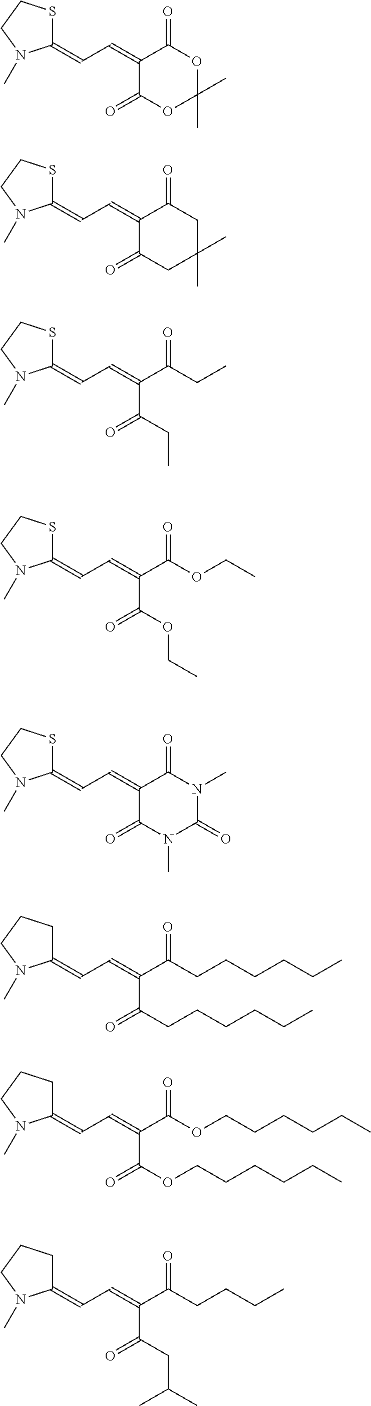

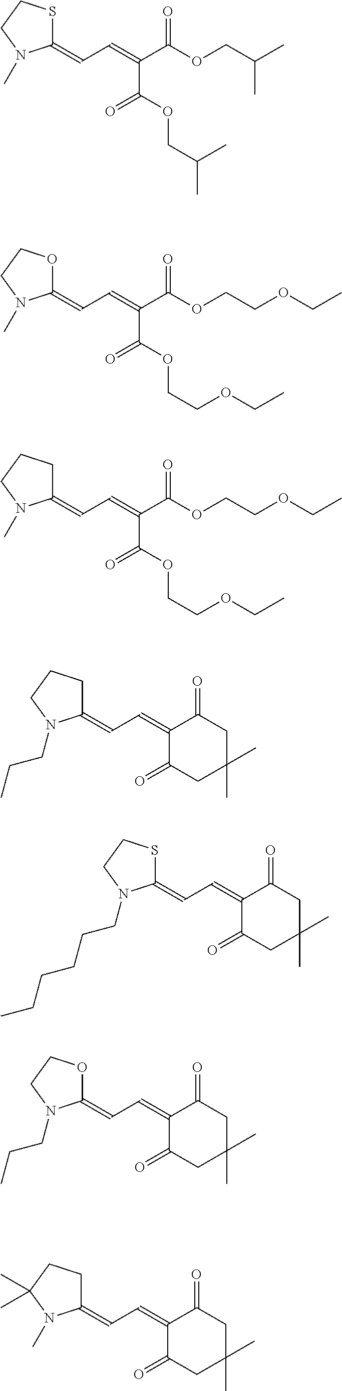

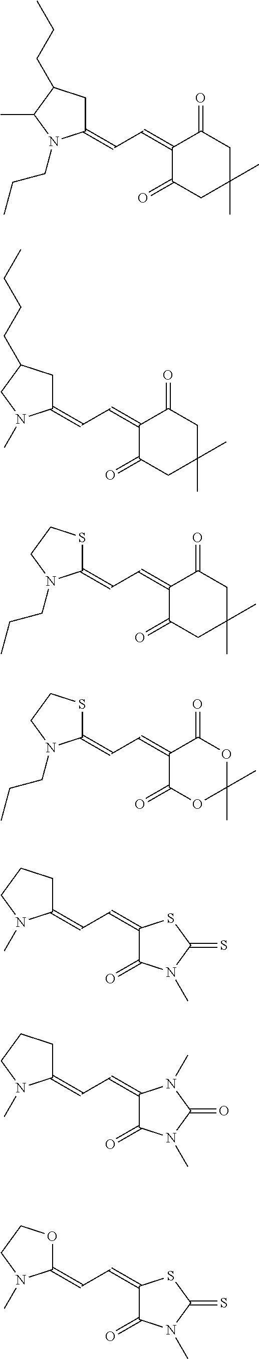

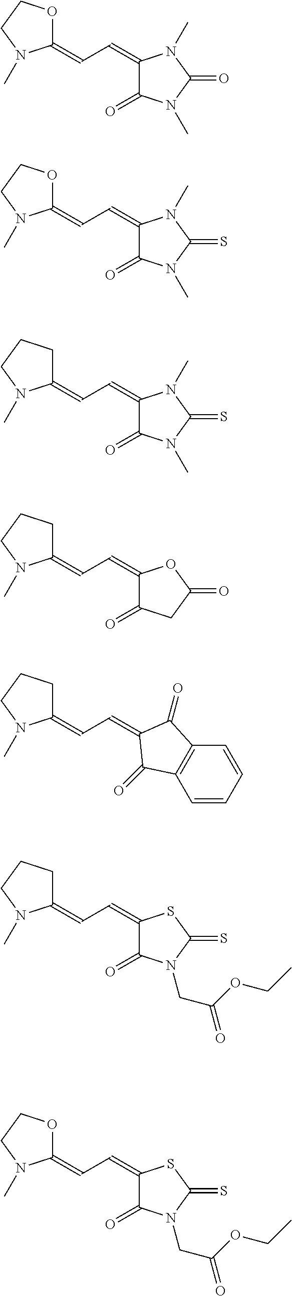

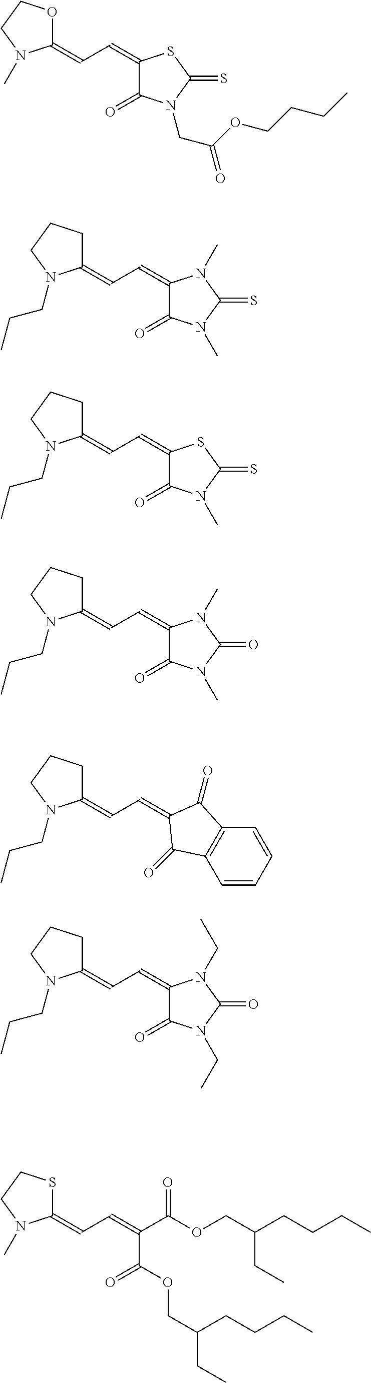

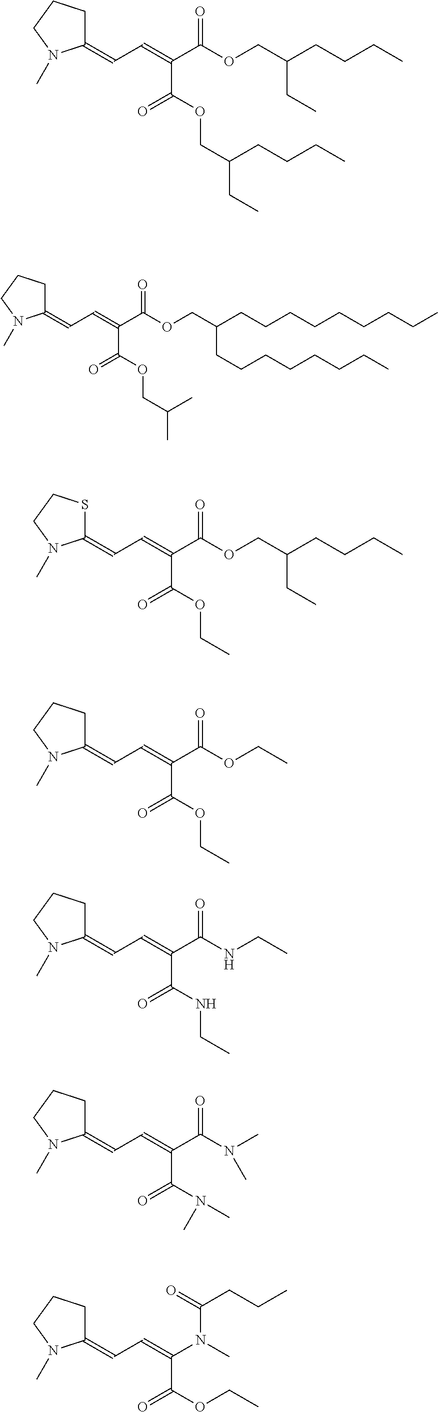

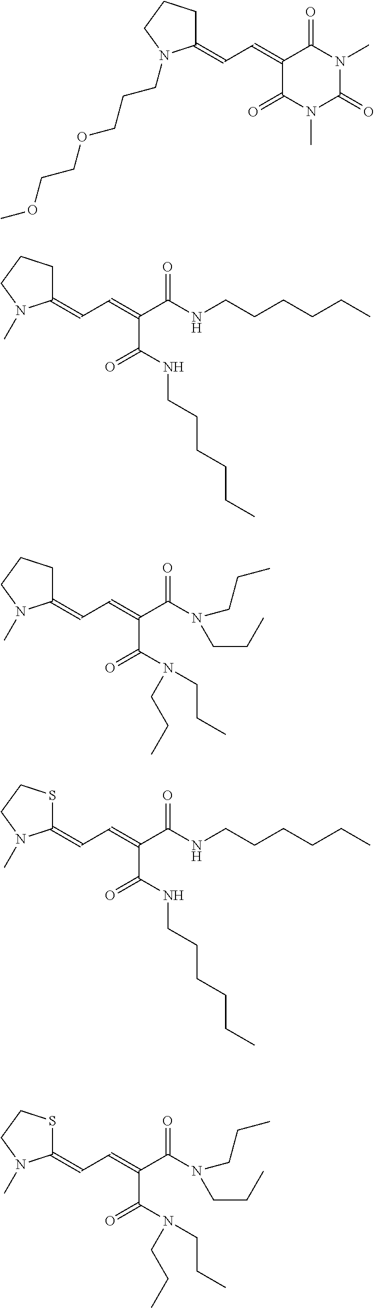

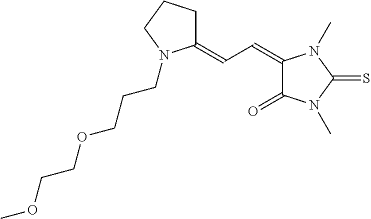 [SMILES: COCCOCCCN1CCC/C1=C\C=C1/C(=O)N(C)C(=S)N1C]

### <Compounds Represented by the Formula (II)>

R¹⁰ and R¹¹ in the formula (II) each independently represent an alkyl group having 1 to 12 carbon atoms, an aralkyl group, an aryl group, or a heterocyclic group. When R¹⁰ and R¹¹ are each an alkyl group, the number of carbons in the alkyl group is preferably 1 to 10, more preferably 2 to 8, and even more preferably 2 to 6 from the viewpoint of compatibility with the acrylic resin (A) which will be explained later. Here, when the alkyl group has at least one methylene group, at least one of the methylene group is optionally substituted with an oxygen atom or a sulfur atom. Examples of the alkyl group include a methyl group, ethyl group, n-propyl group, isopropyl group, n-butyl group, tert-butyl group, n-hexyl group, n-octyl group, n-decyl group, methoxygroup, ethoxygroup, and isopropoxy group.

In the formula (II), the aralkyl group, aryl group, and heterocyclic group represented by R¹⁰ and R¹¹ may have a substituent. Examples of the substituent include halogen atoms, alkyl groups having 1 to 6 carbon atoms, cyano group, nitro group, methoxy group, ethoxy group, and isopropoxy group. The aralkyl group like this is preferably an aralkyl group having 7 to 10 carbon atoms and examples of the aralkyl group include a benzyl group and phenethyl group. The aryl group is preferably an aryl group having 6 to 12 carbon atoms and examples of the aryl group include a phenyl group and naphthyl group. Also, the heterocyclic group is preferably a heterocyclic group having 3 to 9 carbons and examples of the heterocyclic group include a pyrrolyl group, pyridyl group, pyrrolidyl group, quinolyl group, thiophene group, imidazolyl group, oxazolyl group, pyrrole group, thiazolyl group, and furanyl group.

Also, R¹⁰ and R¹¹ may be combined to form a ring structure. Examples of the ring structure formed by R¹⁰ and R¹¹ include four to eight-membered nitrogen-containing ring structures, and five- or six-membered nitrogen-containing ring structures are preferable. Examples of these ring structures include a pyrrolidine ring, pyrroline ring, imidazolidine ring, imidazoline ring, oxazoline ring, thiazoline ring, piperidine ring, morpholine ring, and piperazine ring. Also, these rings may have substituents. Examples of the substituent include the same ones as those exemplified as the substituents which the aryl group and heterocyclic group represented by R¹⁰ and R¹¹ may have.

Examples of R⁴, R⁵, X¹, and X² in the formula (II) include the same ones as those exemplified in the formula (I).

The compound represented by the formula (II) is preferably a compound represented by the formula (II) in which X¹ and X² are each independently —CO—, —COO—, or —CONR⁹—. Also, a compound represented by the formula (II) in which R¹⁰ and R¹¹ are each independently an alkyl group having 1 to 10 carbon atoms and a compound represented by the formula (II-1) are also preferable:

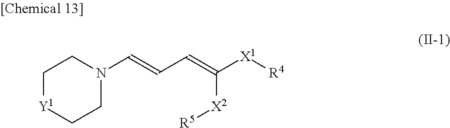

In the formula (II-1), Y¹ represents a methylene group or an oxygen atom and R⁴, R⁵, X¹, and X² have the same meanings as those in the formula (I). Compounds having such a structure are preferable from the viewpoint of compatibility with the acrylic resin (A) which will be explained later and particularly excellent light fastness.

The compound represented by the formula (II) is preferably a compound represented by the formula (II-2):

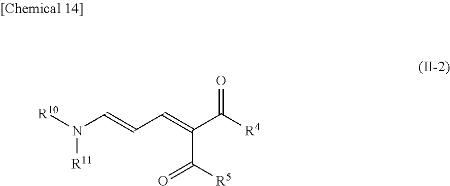

In the formula (II-2), R⁴, R⁵, R¹⁰, and R¹¹ have the same meanings as those in the formula (I) or (II). The compound represented by the formula (II-2) is preferable from the viewpoint of compatibility with the acrylic resin which will be explained later and particularly excellent light fastness and also from the viewpoint of economical productivity.

The compound represented by the formula (II-2) is more preferably compounds represented by the formulae (II-3) to

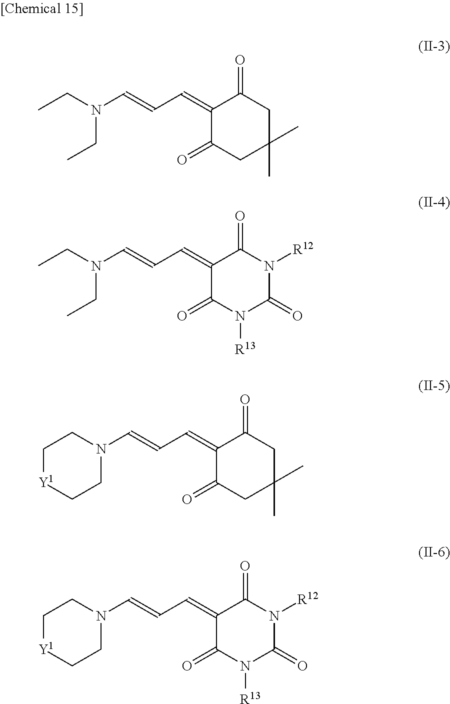

In the formulae, Y¹ represents a methylene group or an oxygen atom, R¹ has the same meaning as that in the formula (I), and R¹² and R¹³ have the same meanings as those in the formula (I-3).

The compounds represented by the formulae (II-3) to (II-6) are preferable from the viewpoint of compatibility with the acrylic resin (A) which will be explained later and particularly excellent light fastness and also from the viewpoint of particularly excellent light-selective absorptivity.

Examples of the compound represented by the formula (II) include the following compounds.

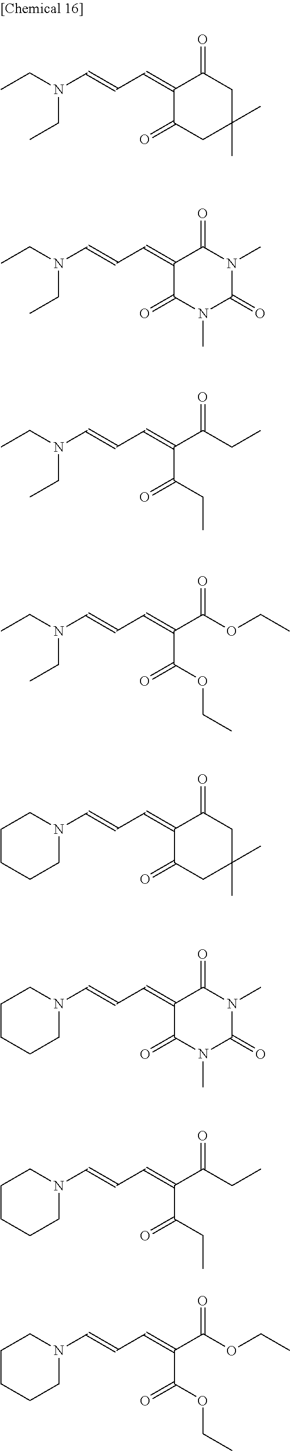

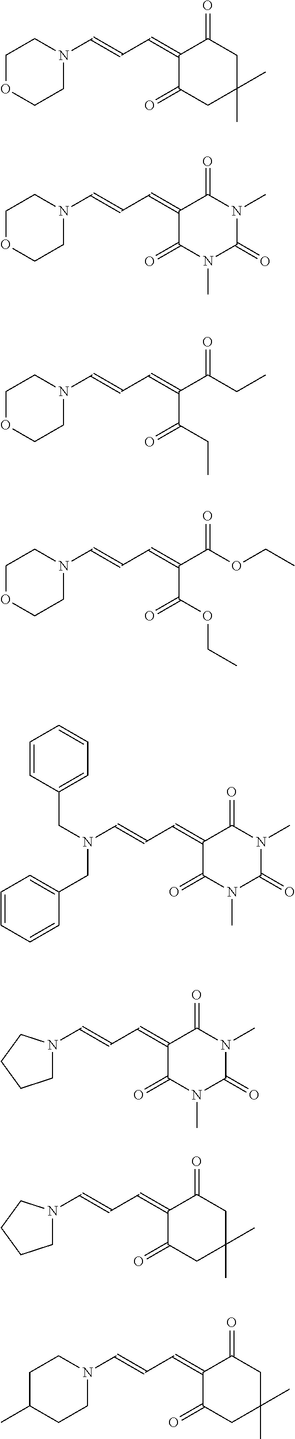

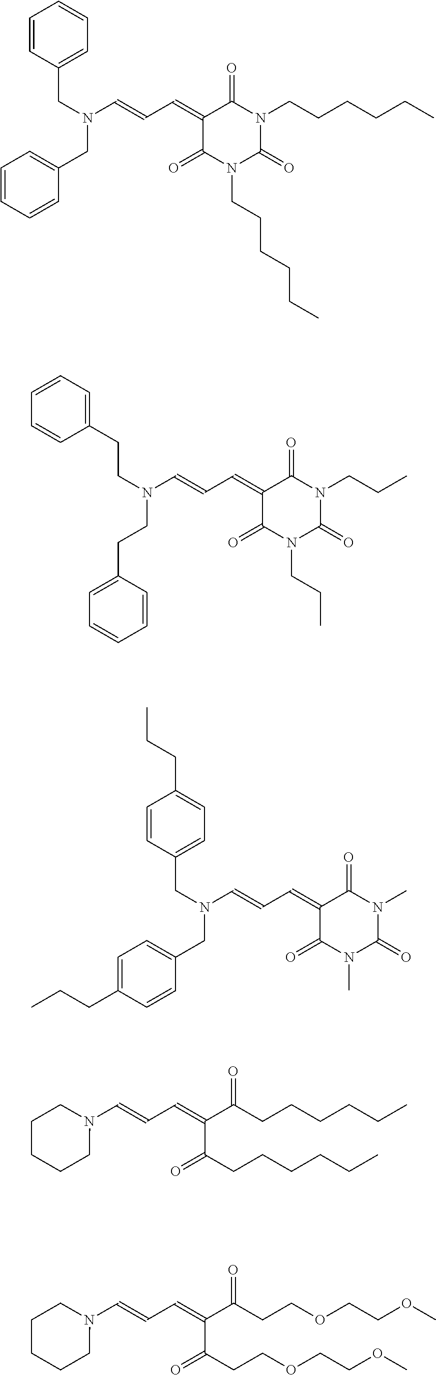

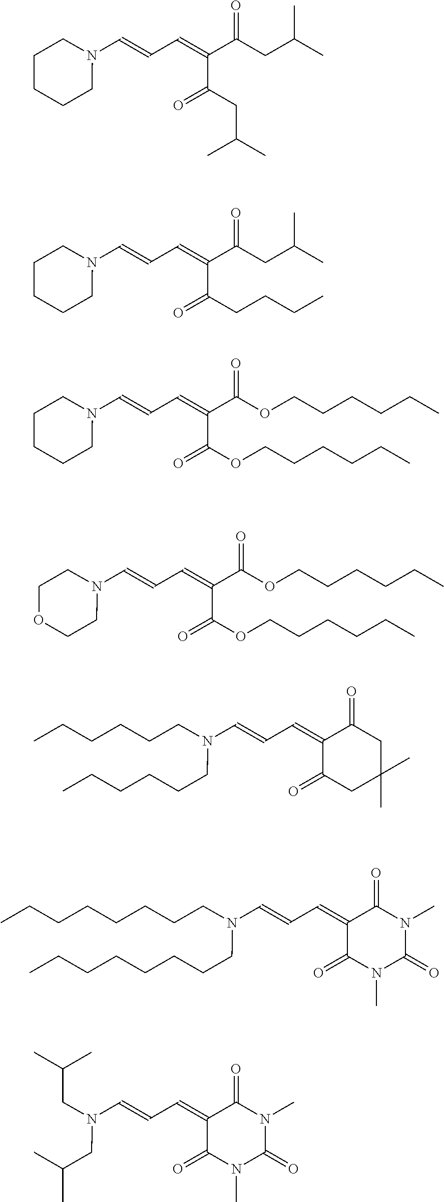

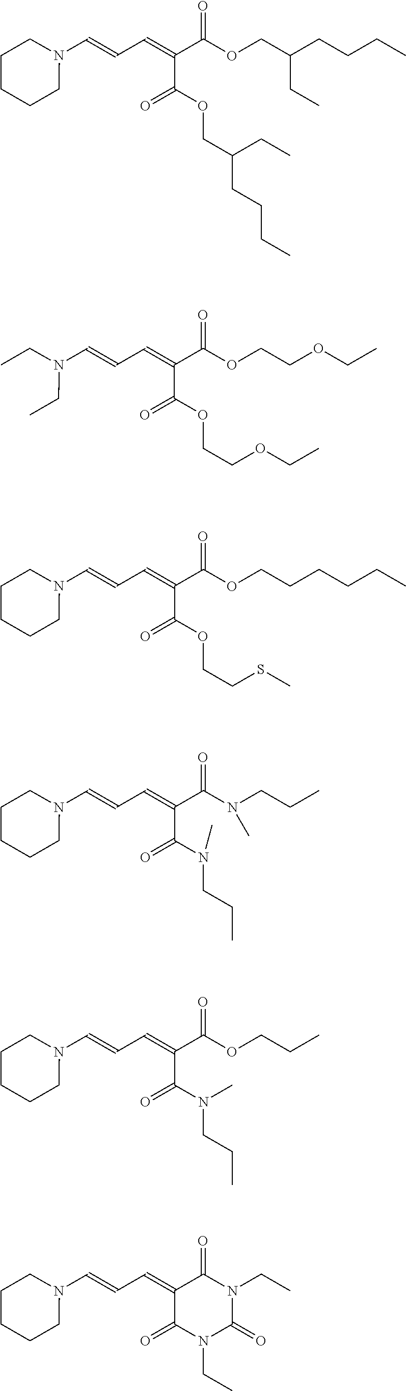

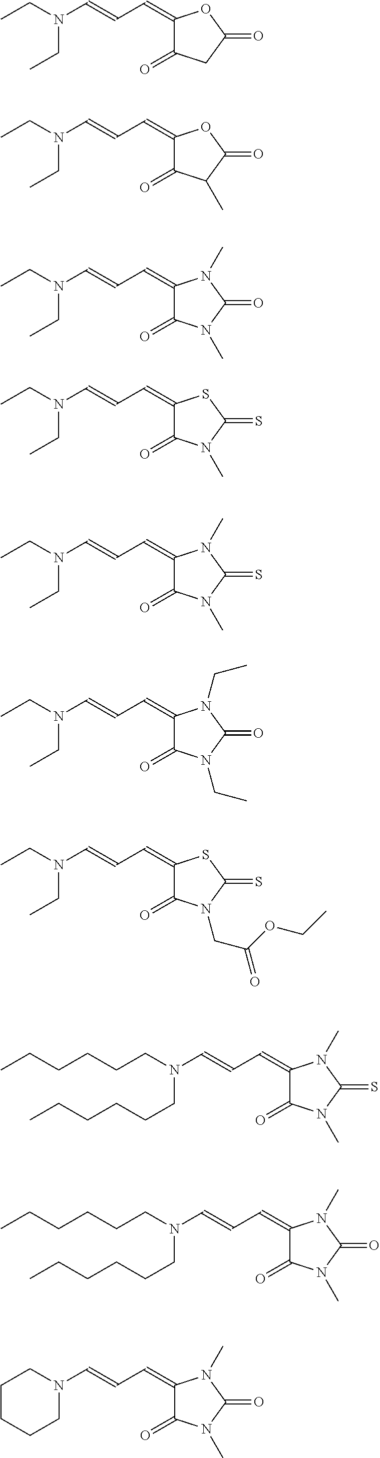

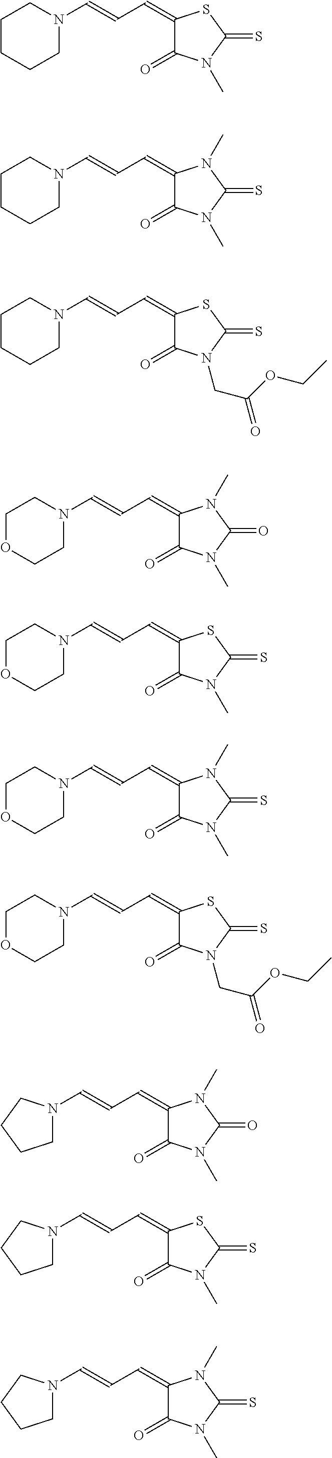

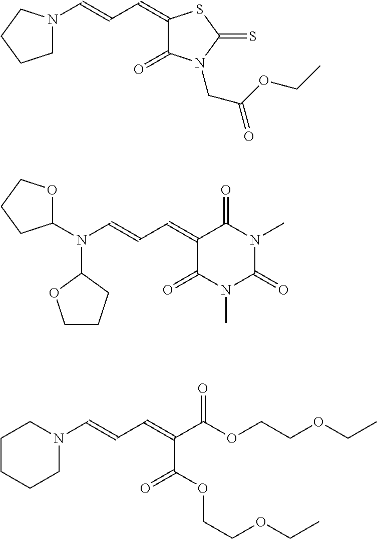 [SMILES: CCOC(=O)CN1C(=O)/C(=C\C=C\N2CCCC2)SC1=S ; CN1C(=O)C(=C/C=C/N(C2CCCO2)C2CCCO2)C(=O)N(C)C1=O ; CCOCCOC(=O)C(=C/C=C/N1CCCCC1)C(=O)OCCOCC]

### <Compounds Represented by the Formula (II)>

In the formula (III), Z¹ represents a hydrogen atom, an alkyl group having 1 to 6 carbon atoms, an aralkyl group, an aryl group, or a heterocyclic group. Here, when the alkyl group has at least one methylene group, at least one of the methylene group is optionally substituted with a secondary amino group, an oxygen atom, or a sulfur atom. Examples of the alkyl group include a methyl group, ethyl group, n-propyl group, isopropyl group, n-butyl group, tert-butyl group, n-hexyl group, methoxy group, ethoxy group, and isopropoxy group.

The aralkyl group, aryl group, and heterocyclic group represented by Z¹ may have a substituent. Examples of the substituent include the same ones as those exemplified as the substituent which the aralkyl group, aryl group, and heterocyclic group represented by R¹⁰ and R¹¹ may have. The aralkyl group is preferably an aralkyl group having 7 to 10 carbon atoms and examples of the aralkyl group include a benzyl group and phenethyl group. The aryl group is preferably an aryl group having 6 to 12 carbon atoms and examples of the aryl group include a phenyl group and naphthyl group. Also, the heterocyclic group is preferably a heterocyclic group having 3 to 9 carbon atoms and examples of the heterocyclic group include pyrrolyl group, pyridyl group, pyrrolidyl group, quinolyl group, thiophene group, imidazolyl group, oxazolyl group, pyrrole group, thiazolyl group, and furanyl group. Z¹ is preferably a hydrogen atom, a phenyl group, or a naphthyl group and more preferably a hydrogen atom or a phenyl group from the viewpoint of production easiness.

In the formula (III), X³ and X⁴ each independently represent an electron-attracting group. Examples of the electron-attracting group include —CN (cyano group), —NO₂ (nitro group), halogen atom, alkyl group substituted with a halogen atom, —Y²—R¹⁴ (wherein R¹⁴ represents a hydrogen atom, an alkyl group having 2 to 50 carbon atoms or an alkyl group having 2 to 50 carbon atoms and at least one methylene group in which at least one of the methylene group is substituted with an oxygen atom, wherein substituent may be bonded to a carbon atom on the alkyl group, Y² represents —CO—, —COO—, —OCO—, —CS—, —CSO—, —NR¹⁵CO—, or —CONR¹⁶— (R¹⁵ and R¹⁶ each independently represent a hydrogen atom, an alkyl group having 1 to 6 carbon atoms, or a phenyl group). X³ and X⁴ are each independently preferably —CN, —CO—, or —COO—, and more preferably X³ and X⁴ are both —CN from the viewpoint of the light fastness of the compound and light-selective absorptivity.

Examples of R¹ in the formula (III) include the same ones as those exemplified in the formula (I).

The compound represented by the formula (III) is more preferably a compound represented by the formula (III-1):

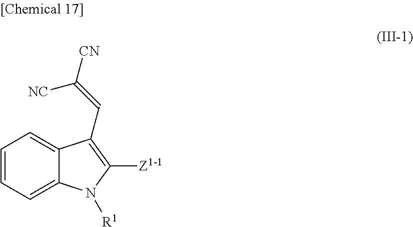

In the formula, Z¹⁻¹ represents a hydrogen atom or a phenyl group and R¹ has the same meaning as that in the formula (I). The compound represented by the formula (III-1) is preferable from the viewpoint of compatibility with the acrylic resin (A) which will be explained later.

Examples of the compound represented by the formula (III) include the following compounds.

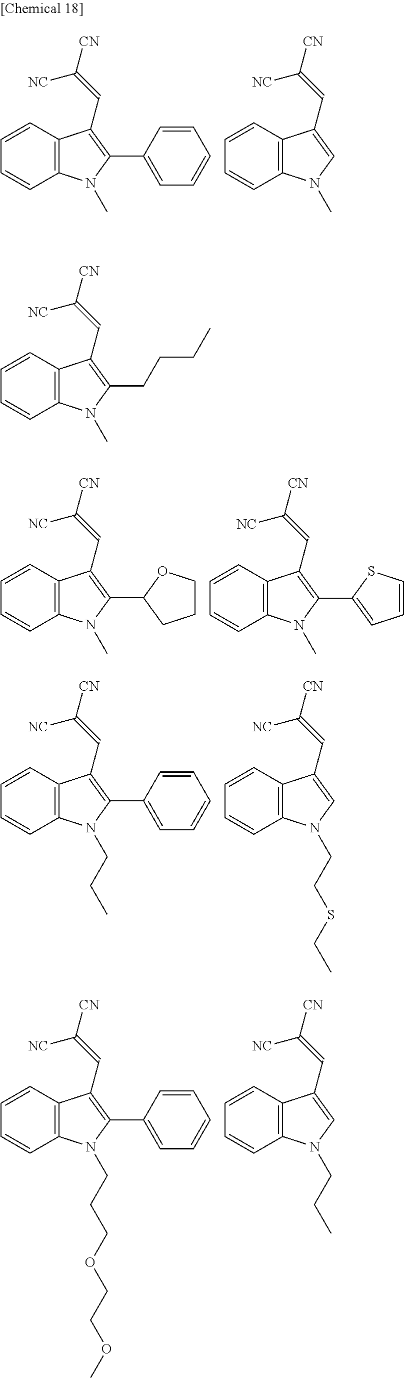

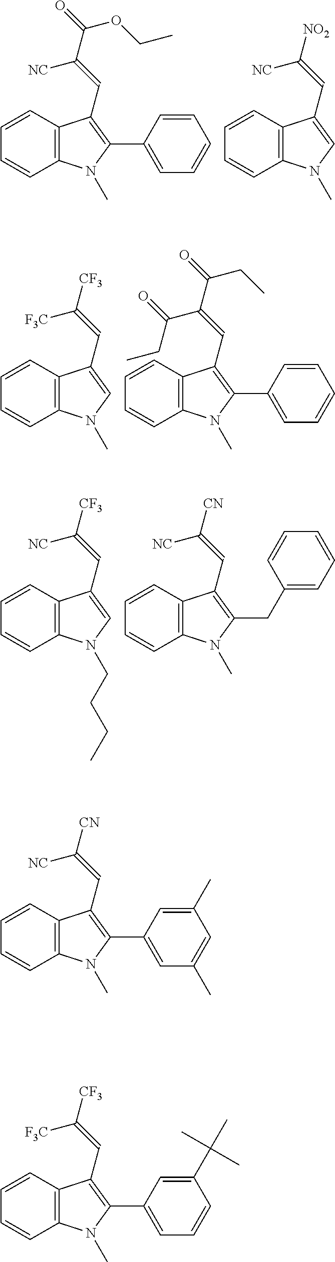

The light-selective absorption compound in the present invention preferably contains at least one compound selected from the group consisting of a compound represented by the formula (I), a compound represented by the formula (II), and a compound represented by the formula (III). Compounds represented by the formulae (I), (II), and (III) may be used either singly or in combinations of two or more different compounds.

The compound represented by the formula (I) may be, for example, produced by reacting 2-methylpyrroline with a methylating agent to form a 1, 2-dimethylpyrrolinium salt, which is then reacted with N,N′-diphenylformamidine and finally with an active methylene compound in the presence of acetic acid anhydride and an amine catalyst. The compound represented by the formula (II) may be produced by reacting an active methylene compound with malonaldehyde dianilide hydrochloride in the presence of an amine catalyst and then with a secondary amine. The compound represented by the formula (III) may be produced, for example, by reacting an active methylene compound with indole-3-carboxyaldehyde in the presence of a base catalyst. Also, commercially available products put in the market as these compounds may be used.

The absorption characteristics of the optical film of the present invention can be controlled by formulating the above light-selective absorption compound. The content of the light-selective absorption compound may be appropriately determined according to, for example, the kinds and combinations of the light-selective absorption compounds to be used, the kind and amount of solvent, the layer in which the light-selective absorption compound is formulated and the thickness of the layer (for example, a pressure-sensitive adhesive layer).

Moreover, the optical film of the present invention may contain a known UV absorber which is usually used in the fields concerned and exhibits absorption in a wavelength range of about 200 to 400 nm besides the light-selective absorption compound exhibiting high selective absorbability in a wavelength range around 420 nm. Examples of the UV absorber include 2-(5-chloro-2H-benzotriazole-2-yl)-6-tert-butyl-4-methylphenol, 2-(4,6-diphenyl-1,3,5-triazine-2-yl)-5-[2-(2-ethylhexazonoyloxy)ethoxy]phenol, and 2,4,6-tris(2-hydroxy-4-hexyloxy-3-methylphenyl)-1,3,5-triazine. By using the UV absorber together, the deterioration caused by ultraviolet rays in the performance of various types of members constituting a display device can be reduced and therefore, the light fastness of the optical film can be more improved.

Here, although at least one pressure-sensitive adhesive layer is preferably contained as the structural member constituting the optical film of the present invention, there is no particular limitation to these structural members as long as these members are so constituted as to exhibit a desired optical function. The pressure-sensitive adhesive layer can exist in the interior structure of the optical film as a component and can exist on the outermost surface of the optical film. Examples of the optical film containing these structural members include optical films (laminated optical films) containing a polarizing plate besides a pressure-sensitive adhesive layer as the structural members and optical films (laminated optical films) further containing a retardation film as the structural members. Although no particular limitation is imposed on the layer structure of these various structural members, optical films such as a polarizing plate and retardation film are usually applied to a display device with a pressure-sensitive adhesive layer disposed therebetween.

In the optical film of the present invention, the light-selective absorption compound may be contained in, for example, a pressure-sensitive adhesive layer, polarizing plate, protection film, or retardation film. Particularly, the pressure-sensitive adhesive layer preferably contains the light-selective absorption compound from the viewpoint of developing a thin-layered optical film.

The structure of the optical film of the present invention in a preferred embodiment of the present invention will be hereinafter explained in detail.

### Pressure-Sensitive Adhesive Layer

In the present invention, a pressure-sensitive adhesive containing a base polymer such as an acrylic type, rubber type, urethane type, silicone type, or polyvinyl ether type may be used as the pressure-sensitive adhesive constituting the pressure-sensitive adhesive layer. Among these compounds, the pressure-sensitive adhesive layer constituting the optical film of the present invention is preferably formed from a pressure-sensitive adhesive composition containing an acrylic resin as the base polymer from the viewpoint of high heat resistance and light fastness.

In a preferred embodiment of the present invention, the pressure-sensitive adhesive layer of the optical film is formed from a pressure-sensitive adhesive composition containing;

(A) an acrylic resin;

(B) a crosslinking agent; and

(C) a light-selective absorption compound satisfying the formula (3).

### <Acrylic Resin (A)>

The acrylic resin forming the pressure-sensitive adhesive layer constituting the optical film of the present invention is preferably an acrylic resin (hereinafter referred to as “acrylic resin (A) according to the case) which is a copolymer containing, as structural components, a (meth)acrylate monomer (hereinafter referred to as “monomer (A-1)” according to the case) represented by the formula (A-1) and an unsaturated monomer (A-2) (hereinafter referred to as “monomer (A-2)” according to the case) having a polar functional group.

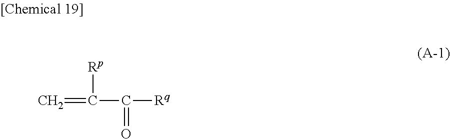

In the formula (A-1), R^{p} represents a hydrogen atom or a methyl group. R^{q} represents an alkyl group having 1 to 20 carbon atoms or an aralkyl group and is preferably an alkyl group having 1 to 10 carbon atoms or aralkyl group, in which hydrogen atoms constituting the alkyl group or aralkyl group are optionally substituted with —O—(C₂H₄O)ₙ—R^{r}. Here, n represents an integer of preferably 0 to 4 and more preferably 0 to 3 and R^{r} represents an alkyl group having preferably 1 to 12 carbon atoms and more preferably 1 to 5 carbon atoms or an aryl group having preferably 1 to 12 carbon atoms and more preferably 1 to 10 carbon atoms.

Examples of the monomer (A-1) include linear alkyl acrylates such as methyl acrylate, ethyl acrylate, propyl acrylate, n-butyl acrylate, n-octyl acrylate, and lauryl acrylate; branched alkyl acrylates such as isobutyl acrylate, 2-ethylhexyl acrylate, and isooctyl acrylate; linear alkyl methacrylates such as methyl methacrylate, ethyl methacrylate, propyl methacrylate, n-butyl methacrylate, n-octyl methacrylate, and lauryl methacrylate; branched alkyl methacrylates such as isobutyl methacrylate, 2-ethylhexyl methacrylate, and isooctyl methacrylate; acrylates having an aromatic group such as phenyl acrylate and benzyl acrylate; and methacrylates having an aromatic group such as phenoxy acrylate, phenyl methacrylate and benzyl methacrylate. These compounds may be used either independently or in combinations of two or more. Among these compounds, n-butyl acrylate is preferable from the viewpoint of developing adhesion.

In the monomer (A-2), the polar functional group may be a free carboxyl group, hydroxyl group, amino group, and heterocyclic groups including an epoxy ring. The monomer (A-2) is preferably a (meth)acrylic acid type compound having a polar functional group. Examples of the (meth)acrylic acid type compound include unsaturated monomers having a free carboxyl group, such as acrylic acid, methacrylic acid, and 3-carboxyethylacrylate; unsaturated monomers having a hydroxyl group, such as 2-hydroxylethyl (meth)acrylate, 2-hydroxypropyl (meth)acrylate, 2- or 3-chloro-2-hydroxypropyl (meth)acrylate, and diethylene glycol mono (meth)acrylate; unsaturated monomers having a heterocyclic group such as acryloyl morpholine, vinyl caprolactam, N-vinyl-2-pyrrolidone, tetrahydrofurfuryl (meth)acrylate, caprolactone-modified tetrahydrofurfuryl acrylate, 3,4-epoxycyclohexylmethyl (meth)acrylate, glycidyl (meth)acrylate, and 2,5-dihydrofuran; and unsaturated monomers having an amino group different from a heteroring, such as N,N-dimethylaminoethyl (meth)acrylate. These monomers (A-2) may be used either independently or in combinations of two or more.

Among these compounds, an unsaturated monomer having a hydroxyl group is preferably contained as one of the monomers (A-2) constituting the acrylic resin (A) from the viewpoint of improving the adhesion of the pressure-sensitive adhesive layer and more improving durability.

The acrylic resin (A) including a monomer (A-1) and a monomer (A-2) as structural units contains a structural unit derived from the monomer (A-1) in an amount of preferably 50 to 99.9% by mass and more preferably 70 to 99.9% by mass based on the total resin solid content. Also, the acrylic resin (A) contains a structural unit derived from the monomer (A-2) in an amount of preferably 0.1 to 50% by mass and more preferably 0.1 to 30% by mass. When the ratios of the monomer (A-1) and the monomer (A-2) fall in the above ranges, a pressure-sensitive adhesive composition can be obtained which provides a pressure-sensitive adhesive layer superior in processability.

Moreover, the acrylic resin (A) may contain, as a structural component, a monomer (hereinafter referred to as “monomer (A-3)” according to the case) other than the monomers (A-1) and (A-2). Examples of the other monomer may include (meth)acrylates having an alicyclic structure in its molecule, styrene type monomers, vinyl type monomers, monomers each having a plurality of (meth)acryloyl groups in its molecule, and (meth)acrylamide derivatives.

The alicyclic structure means a cycloparaffin structure having usually 5 or more and preferably about 5 to 7 carbon atoms. Examples of the acrylate having an alicyclic structure include isobornyl acrylate, cyclohexyl acrylate, dicyclopentanyl acrylate, cyclododecyl acrylate, methylcyclohexyl acrylate, trimethylcyclohexyl acrylate, tert-butylcyclohexyl acrylate, cyclohexyl α-ethoxyacrylate, and cyclohexylphenyl acrylate. Examples of the methacrylate having an alicyclic structure include isobornyl methacrylate, cyclohexyl methacrylate, dicyclopentanyl methacrylate, cyclododecyl methacrylate, methylcyclohexyl methacrylate, trimethylcyclohexyl methacrylate, tert-butylcyclohexyl methacrylate, and cyclohexylphenyl methacrylate.

Examples of the styrene type monomer may include, besides styrene, alkyl styrenes such as methylstyrene, dimethylstyrene, trimethylstyrene, ethylstyrene, diethylstyrene, triethylstyrene, propylstyrene, butylstyrene, hexylstyrene, heptylstyrene, and octylstyrene; halogenated styrenes such as fluorostyrene, chlorostyrene, bromostyrene, dibromostyrene, and iodostyrene; and further, nitrostyrene, acetylstyrene, methoxystyrene, and divinylbenzene.

Examples of the vinyl type monomer may include aliphatic acid vinyl esters such as vinyl acetate, vinyl propionate, vinyl butylate, vinyl 2-ethylhexanoate, and vinyl laurate; vinyl halides such as vinyl chloride and vinyl bromide; vinylidene halides such as vinylidene chloride; nitrogen-containing aromatic vinyls such as vinylpyridine, vinylpyrrolidone, and vinylcarbazole; conjugated diene monomers such as butadiene, isoprene, and chloroprene; and further, acrylonitrile, and methacrylonitrile.

Examples of the monomer having a plurality of (meth)acryloyl groups in its molecule may include monomers each having two (meth)acryloyl groups in its molecule, such as 1,4-butanediol di(meth)acrylate, 1,6-hexanediol di(meth)acrylate, 1,9-nonanediol di(meth)acrylate, ethylene glycol di(meth)acrylate, diethylene glycol di(meth)acrylate, tetraethylene glycol di(meth)acrylate, and tripropylene glycol di(meth)acrylate; and monomers having three (meth)acryloyl groups in its molecule, such as trimethylopropane tri(meth)acrylate.

Examples of the (meth)acrylamide derivatives may include N-methylol(meth)acrylamide, 2-hydroxyethyl(meth)acrylamide, 3-hydroxypropyl(meth)acrylamide, 4-hydroxybutyl(meth)acrylamide, 5-hydroxypentyl(meth)acrylamide, 6-hydroxyhexyl(meth)acrylamide, N-methoxymethyl(meth)acrylamide, N-ethoxymethyl(meth)acrylamide, N-propoxymethyl(meth)acrylamide, N-butoxymethyl(meth)acrylamide, N,N-dimethyl(meth)acrylamide, N,N-diethyl(meth)acrylamide, N-isopropyl(meth)acrylamide, N-dimethylaminopropyl(meth)acrylamide, N-(1,1-dimethyl-3oxobutyl)(meth)acrylamide, N-[2-(2-oxo-1-imidazolidinyl)ethyl](meth)acrylamide, and 2-acryloylamino-2-methyl-1-propanesulfonic acid.

The above monomer (A-1), monomer (A-2), and other monomer (A-3) may be used either independently or in combinations of two or more. In the present invention, the structural unit derived from the above monomer (A-3) in the acrylic resin (A) which may be used in the pressure-sensitive adhesive composition is contained in an amount of usually 0 to 20 parts by mass and preferably 0 to 10 parts by mass based on the total solid content of the acrylic resin (A).

The weight average molecular weight (Mw) of the above acrylic resin (A) measured in terms of standard polystyrene by gel permeation chromatography (GPC) is preferably 500000 to 2000000, more preferably 600000 to 1800000, and even more preferably 700000 to 1700000. When the weight average molecular weight measured in terms of standard polystyrene is 500000 or more, this is desirable because this improves adhesion under high-temperature and high humidity, tends to reduce the possibility of occurrences of lifting and delamination between the glass substrate (image display device) and the pressure-sensitive adhesive layer and also tends to improve reworkability. Also, when this weight average molecular weight is 2000000 or less, this is desirable because even if an optical film or the like is changed in dimension when the pressure-sensitive adhesive layer is applied to the optical film, the pressure-sensitive adhesive sheet changes corresponding to the dimensional change and there is therefore a tendency that a difference in brightness between the peripheral parts and center of an image display device such as a liquid crystal cell is decreased, resulting in the reduction of white voids and color unevenness. The molecular weight distribution expressed by the ratio (Mw/Mn) of the weight average molecular weight (Mw) to the number average molecular weight (Mn) is generally in a range from about 2 to 10.

The aforementioned acrylic resin (A) may be produced by each of the known various methods such as a solution polymerization method, emulsion polymerization method, block polymerization method, and suspension polymerization method. In the production of this acrylic resin, a polymerization initiator is usuallyused. The polymerization initiator is used in an amount of about 0.001 to 5 parts by mass based on 100 parts by mass of all monomers to be used in the production of the acrylic resin.

As the polymerization initiator, a thermopolymerization initiator, photopolymerization initiator, or the like is used. Examples of the photopolymerization initiator may include 4-(2-hydroxyethoxy)phenyl(2-hydroxy-2-propyl)ketone. Examples of the thermopolymerization initiator may include azo type compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl-2,2′-azobis(2-methylpropionate), and 2,2′-azobis(2-hydroxymethylpropionitrile); organic peroxides such as lauryl peroxide, tert-butyl hydroperoxide, benzoyl peroxide, tert-butylperoxybenzoate, cumene hydroperoxide, diisopropylperoxydicarbonate, dipropylperoxydicarbonate, tert-butylperoxyneodecanoate, tert-butylperoxypivalate, and (3,5,5-trimethylhexanoyl)peroxide; and inorganic peroxides such as potassium peroxide, ammonium peroxide, and hydrogen peroxide. Also, for example, a redox type initiator using a combination of a peroxide and a reducing agent may be used as the polymerization initiator.

Among the methods shown above, the solution polymerization method is preferable as the method for producing the acrylic resin (A). Taking the solution polymerization method as an example to explain, the following method may be given as the example. Specifically, a desired monomer and an organic solvent are mixed with each other and a thermopolymerization initiator is added to the mixture in a nitrogen atmosphere to stir the mixture at a temperature of about 40 to 90° C. and preferably 50 to 80° C. for about 3 to 12 hours. Also, a monomer and a thermopolymerization initiator may be added continuously or intermittently during polymerization or may be added in a solution state where these ingredients are dissolved in an organic solvent to control the reaction. Here, as the organic solvent, aromatic hydrocarbons such as toluene and xylene; esters such as ethyl acetate and butyl acetate; aliphatic alcohols such as propyl alcohol and isopropyl alcohol; and ketones such as acetone, 2-butanone, and methyl isobutyl ketone may be used.

In an embodiment of the present invention, the pressure-sensitive adhesive composition may contain one or two or more types among the above acrylic resins (A).

The pressure-sensitive adhesive composition may contain, besides the above acrylic resin (A), an acrylic resin different from the acrylic resin (A). Examples of the acrylic resin may include those which each contain, as its major component, a structural unit which is derived from (meth)acrylates (for example, polymethyl (meth)acrylate) and each have such a relatively low molecular weight that it has a weight average molecular weight ranging from 50000 to 300000.

When the pressure-sensitive adhesive composition contains an acrylic resin different from the acrylic resin (A), the content of the acrylic resin different from the acrylic resin (A) is usually preferably 50 parts by mass or less and more preferably 30 parts by mass or less based on 100 parts by mass of the acrylic resin (A).

A solution adjusted to a solid concentration of 20% by mass by dissolving the acrylic resin (a mixture of two or more types when they are combined) to be contained in the pressure-sensitive adhesive composition in ethyl acetate preferably has a viscosity of 20 Pa's or less and more preferably 0.1 to 7 Pa·s at 25° C. When the viscosity is 20 Pa·s or less, this is desirable because adhesion under a high-temperature and high-humidity condition is improved and there is therefore a tendency that the possibility of occurrences of lifting and delamination between the display device and the pressure-sensitive adhesive layer is reduced and also the reworkability is improved. The viscosity may be measured by a Brookfield viscometer.

### <Crosslinking Agent>

In the present invention, the pressure-sensitive adhesive composition may contain a crosslinking agent. For example, a compound is used, as the crosslinking agent, which reacts with, particularly, a structural unit derived from an unsaturated monomer having a polar functional group in the acrylic resin (A) to crosslink the acrylic resin (A). Examples of the crosslinking agent include an isocyanate type compound, epoxy type compound, aziridine type compound, and metal chelating type compound. Among these compounds, the isocyanate type compound, epoxy type compound, and aziridine type compound each contain, in its molecule, at least two functional groups which can react with the polar functional group in the acrylic resin (A).

The isocyanate type compound is a compound having at least two isocyanate groups (—NCO) in its molecule and examples of the isocyanate type compound include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, naphthalene diisocyanate, and triphenylmethane triisocyanate. Also, adducts obtained by reacting polyols such as glycerol and trimethylolpropane with these isocyanate compounds and dimers or trimers of these isocyanate compounds may be used as the crosslinking agent to be used for the pressure-sensitive adhesive. Two or more types of isocyanate type compounds may be used in combinations.

The epoxy type compound is a compound having at least two epoxy groups in its molecule and examples of the epoxy type compound include a bisphenol A-type epoxy resin, ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, N,N-diglycidylaniline, N,N,N′,N′-tetraglycidyl-m-xylenediamine, and 1,3-bis(N,N′-diglycidylaminomethyl)cyclohexane. Two or more types of epoxy type compounds may be mixed to use.

The aziridine type compound is a compound having, in its molecule, at least two three-membered ring skeletons also called ethyleneimine consisting of one nitrogen atom and two carbon atoms and examples of the aziridine type compound include diphenylmethane-4,4′-bis(1-aziridinecarboxamide), toluene-2,4-bis(1-aziridinecarboxamide), triethylenemelamine, isophthaloylbis-1-(2-methylaziridine), tris-1-aziridinylphosphine oxide, hexamethylene-1,6-bis(1-aziridinecarboxamide), trimethylolpropane-tri-β-aziridinylpropionate, and tetramethylolmethane-tri-β-aziridinylpropionate.

Examples of the metal chelating compound include compounds in which acetylacetone or ethyl acetoacetate is coordinated with a polyvalent metal such as aluminum, iron, copper, zinc, tin, titanium, nickel, antimony, magnesium, vanadium, chromium, and zirconium.

Among these crosslinking agents, for example, an isocyanate type compound and particularly, xylylene diisocyanate, tolylene diisocyanate, or hexamethylene diisocyanate, or adducts obtained by reacting these isocyanate compounds with polyols such as glycerol and trimethylolpropane, a mixture of dimers or trimers of these isocyanate compounds, or a mixture of these isocyanate type compounds are preferably used. Preferred examples of the isocyanate type compound include tolylene diisocyanate, adducts obtained by reacting tolylene diisocyanate with polyols, dimers of tolylene diisocyanate, trimers of tolylene diisocyanate, hexamethylene diisocyanate, adducts obtained by reacting hexamethylene diisocyanate with polyols, dimers of hexamethylene diisocyanate, and trimers of hexamethylene diisocyanate.

In the present invention, the pressure-sensitive adhesive composition contains preferably 0.01 to 10 parts by mass, more preferably 0.01 to 0.08 parts by mass, and even more preferably 0.01 to 0.06 parts by mass of the crosslinking agent based on 100 parts by mass of the solid content of the above acrylic resin (total content of two or more types of acrylic resins when these acrylic resins are used in combinations). When the amount of the crosslinking agent is 0.01 parts by mass or more, this is desirable because there is a tendency that the pressure-sensitive adhesive layer is improved in durability. When the amount of the crosslinking agent is 10 parts by mass or less, white voids are made unnoticeable when a pressure-sensitive adhesive obtained from the pressure-sensitive adhesive composition is applied to a liquid crystal display device.

In a preferred embodiment of the present invention, the pressure-sensitive adhesive composition forming the pressure-sensitive adhesive layer constituting the optical film of the present invention contains the acrylic resin (A) which is a copolymer containing, as its structural components, 50 to 99.9% by mass of the monomer (A-1) and 0.1 to 50% by mass of the monomer (A-2) based on the total solid content of the acrylic resin and has a weight average molecular weight of 500000 to 2000000 and 0.01 to 10 parts by mass of a crosslinking agent based on 100 parts by mass of the acrylic resin.

### <Light-Selective Absorption Compound>

Also, in a preferred embodiment of the present invention, the pressure-sensitive adhesive composition contains a light-selective absorption compound satisfying the formula (3). Although the light-selective absorption compound in the optical film of the present invention may be contained in any structural member (layer) constituting the optical film as mentioned above, it is advantageous to contain the light-selective absorption compound in the pressure-sensitive adhesive layer from the viewpoint of developing a thin-layered optical film because the optical film can be formed without forming any protection film by formulating the light-selective absorption compound in the pressure-sensitive adhesive layer.

Examples of the light-selective absorption compound satisfying the formula (3) include the same light-selective absorption compounds as those explained above and for example, compounds represented by the formulae (I), (II), and (III), and the like are preferably used. These light-selective absorption compounds may be used either independently or in combinations of two or more. Because these compounds can produce high absorption effect in a small amount, a pressure-sensitive adhesive layer can be obtained which has high absorption characteristics to a short wavelength range around 420 nm while keeping high adhesion.

The content of the light-selective absorption compound in the pressure-sensitive adhesive composition is preferably 0.01 to 10 parts by mass, more preferably 0.1 to 8 parts by mass, and even more preferably 0.4 to 6 parts by mass based on 100 parts by mass of the solid content of the above acrylic resin (100 parts by mass of the total content of two or more types of acrylic resins when these acrylic resins are used in combinations). When the light-selective absorption compound is contained in an amount falling in the above range, a pressure-sensitive adhesive layer is obtained which has high absorption characteristics to a wavelength range around 420 nm, so that an excellent blue-light cutting function can be provided to an optical film containing these compounds.

Also, in the present invention, the pressure-sensitive adhesive composition preferably contains a silane type compound and it is particularly preferable to formulate a silane type compound in the acrylic resin before the crosslinking agent is formulated. Because a silane type compound improves adhesion to glass, the adhesive force between a display device and the pressure-sensitive adhesive layer sandwiched between glass substrates can be improved by formulating the silane type compound.

Examples of the silane type compound include vinyltrimethoxysilane, vinyltriethoxysilane, N-(2-aminoethyl)-3-aminopropylmethyldimethoxysilane, 3-aminopropyltriethoxysilane, 3-glycidoxypropyltrimethoxysilane, 2-(3,4-epoxycyclohexyl)ethyltrimethoxysilane, 3-chloropropylmethyldimethoxysilane, 3-methacryloyloxypropyltrimethoxysilane, 3-mercaptopropyltrimethoxysilane, and 3-glycidoxypropyldimethoxymethylsilane. Two or more types of silane type compounds may be used.

The silane type compound may be a silicone oligomer type. If silicone oligomers are expressed by a (monomer) oligomer form, the following compounds may be given as examples.

Mercaptopropyl group-containing copolymers such as a 3-mercaptopropyltrimethoxysilane-tetramethoxysilane copolymer, 3-mercaptopropyltrimethoxysilane-tetraethoxysilane copolymer, and 3-mercaptopropyltriethoxysilane-tetramethoxysilane copolymer;

Mercaptomethyl group-containing copolymers such as a mercaptomethyltrimethoxysilane-tetramethoxysilane copolymer, mercaptomethyltrimethoxysilane-tetraethoxysilane copolymer, and mercaptomethyltriethoxysilane-tetraethoxysilane copolymer;

Methacryloyloxypropyl group-containing copolymers such as a 3-methacryloyloxypropyltrimethoxysilane-tetramethoxysilane copolymer, 3-methacryloyloxypropyltrimethoxysilane-tetraethoxysilane copolymer, 3-methacryloyloxypropylmethyldimethoxysilane-tetramethoxysi lane copolymer, and 3-methacryloyloxypropylmethyldiethoxysilane-tetramethoxysilane copolymer;

Acryloyloxypropyl group-containing copolymers such as a 3-acryloyloxypropyltrimethoxysilane-tetramethoxysilane copolymer, 3-acryloyloxypropyltriethoxysilane-tetramethoxysilane copolymer, 3-acryloyloxypropylmethyldimethoxysilane-tetramethoxysilane copolymer, and 3-acryloyloxypropylmethyldiethoxysilane-tetraethoxysilane copolymer;

Vinyl group-containing copolymers such as a vinyltrimethoxysilane-tetramethoxysilane copolymer, vinyltriethoxysilane-tetraethoxysilane copolymer, vinylmethyldimethoxysilane-tetramethoxysilane copolymer, and vinylmethyldiethoxysilane-tetraethoxysilane copolymer; and

Amino group-containing copolymers such as a 3-aminopropyltrimethoxysilane-tetramethoxysilane copolymer, 3-aminopropyltriethoxysilane-tetramethoxysilane copolymer, 3-aminopropylmethyldimethoxysilane-tetraethoxysilane copolymer, and 3-aminopropylmethyldiethoxysilane-tetramethoxysilane copolymer.

Many of these silane type compounds are liquids. The amount of the silane type compound in the pressure-sensitive adhesive composition is usually about 0.01 to 10 parts by mass and preferably 0.01 to 5 parts by mass based on 100 parts by mass of the solid content of the acrylic resin (100 parts by mass of the total content of two or more types of acrylic resins when these acrylic resins are used in combinations). When the amount of the silane type compound is 0.01 parts by mass or more based on 100 parts by mass of the solid content of the acrylic resin, this is desirable because the adhesive force between the pressure-sensitive adhesive layer and the display device is improved. Also, when the amount is 10 parts by mass or less, this is desirable because there is a tendency that the breed-out of the silane type compound from the pressure-sensitive adhesive layer is reduced.

The pressure-sensitive adhesive composition may further contain, for example, a crosslinking catalyst, antistatic agent, weathering stabilizer, tackifier, plasticizer, softener, dyes, pigments, inorganic filler, and resins other than an acrylic resin. Also, it is useful that a UV-curable compound is formulated in the pressure-sensitive adhesive composition and ultraviolet rays are applied to cure the composition after the pressure-sensitive adhesive layer is formed, to thereby increase the hardness of the pressure-sensitive adhesive layer. If, particularly, a crosslinking catalyst is formulated together with the crosslinking agent in the pressure-sensitive adhesive composition, this enables the preparation of the pressure-sensitive adhesive layer by aging the pressure-sensitive adhesive layer in a short time, can reduce the occurrences of lifting and delamination between the polarizing plate, retardation film, or the like and the pressure-sensitive adhesive layer and occurrence of a foaming phenomenon inside the pressure-sensitive adhesive layer in the obtained optical film (laminated optical film), and also sometimes improves reworkability. Examples of the crosslinking catalyst may include amine type compounds such as hexamethylenediamine, ethylenediamine, polyethyleneimine, hexamethylenetetramine, diethylenetriamine, triethylenetetramine, isophoronediamine, trimethylenediamine, polyamino resin, and melamine resin. When an amine type compound is formulated as the crosslinking catalyst in the pressure-sensitive adhesive composition, an isocyanate type compound is preferable as the crosslinking agent.

Each of the aforementioned components constituting the pressure-sensitive adhesive may constitute a pressure-sensitive adhesive composition in the condition where it is dissolved in a solvent. Examples of such a solvent include alcoholic solvents such as methanol, ethanol, ethylene glycol, isopropyl alcohol, propylene glycol, methyl cellosolve, butyl cellosolve, and propylene glycol monomethyl ether; ester solvents such as ethyl acetate, butyl acetate, ethylene glycol methyl ether acetate, γ-butyrolactone, propylene glycol monomethyl ether acetate, and ethyl lactate; ketone solvents such as acetone, 2-butanone, methyl isobutyl ketone, cyclopentanone, cyclohexanone, and methyl amyl ketone; aliphatic hydrocarbon solvents such as pentane, hexane, and heptane; aromatic hydrocarbon solvents such as toluene and xylene; nitrile solvents such as acetonitrile; ether solvents such as tetrahydrofuran and dimethoxyethane; and chlorinated hydrocarbon solvents such as chloroform and chlorobenzene. Among these compounds, 2-butanone, methyl isobutyl ketone, and the like are preferable from the viewpoint of the solubility of each component and also from the viewpoint of reducing environmental loads.

The pressure-sensitive adhesive layer may be formed using, for example, a method in which an organic solvent solution is prepared using a pressure-sensitive adhesive composition like those mentioned above and is applied to a film or layer (for example, a polarizing plate and protection film), on which the adhesive layer is to be laminated, by a die coater or gravure coater, followed by drying. Also, the pressure-sensitive adhesive layer may be formed by a method in which a sheet-like pressure-sensitive adhesive formed on a plastic film (also called a separate film) which has been subjected to release treatment is transferred to a film or layer to be laminated. The thickness of the pressure-sensitive adhesive layer is generally preferably 30 μm or less and 3 μm or more and more preferably 3 to 20 μm though no particular limitation is imposed on the thickness. When the thickness of the pressure-sensitive adhesive layer is 30 μm or less, this is preferable because this improves adhesion under a high-temperature and high-humidity condition, tends to reduce the occurrences of lifting and delamination between a display devices and the pressure-sensitive adhesive layer and also tends to improve reworkability. When this thickness is 3 μm or more, this is desirable because even if an optical film to be applied to the pressure-sensitive adhesive layer is changed in its dimension, the pressure-sensitive adhesive layer changes corresponding to the dimensional change and there is therefore a tendency that a difference in brightness between the peripheral parts and center of a liquid crystal cell (display device) is decreased, resulting in the reduction of white voids and color unevenness.

In the optical film of the present invention, the pressure-sensitive adhesive layer preferably has optical characteristics satisfying the formulae (1) and (2). When the formulae (1) and (2) are satisfied, the optical film containing the pressure-sensitive adhesive layer has high selective absorbability to wavelengths around 420 nm and also has a high blue-light cutting function, ensuring that when it is incorporated into a display device, good display characteristics can be imparted to the display device.

### Optical Film

In the optical film of the present invention, for example, the above pressure-sensitive adhesive layer is laminated on a polarizing plate, retardation film, or the like and an optical film is applied to a display device via the pressure-sensitive adhesive layer.

The optical film of the present invention preferably contains at least one polarizing plate. Here, the polarizing plate means an optical film having a function of polarizing incident light such as natural light to emit polarized light. Examples of the polarizing plate include a linearly polarizing plate (sometimes called a polarizer) having the characteristics that it absorbs linearly polarized light which is incident to the surface of a film and has a plane of vibration propagating in a certain direction and transmits linearly polarized light having the plane of vibration perpendicular to the above direction, a polarization separating film having the characteristics that it reflects linearly polarized light which is incident to the surface of a film and has a plane of vibration propagating in a certain direction and transmits linearly polarized light having the plane of vibration perpendicular to the above direction, and an elliptically polarizing plate obtained by laminating a polarizing plate and a retardation film which will be explained later. Preferred examples of the polarizing plate and especially, the linearly polarizing plate include those in which a dichroic pigment such as iodine or a dichroic dye is adsorbed to and oriented on a uniaxially stretched polyvinyl alcohol resin film or a polymer of polymerizable liquid crystal compounds.

When the optical film of the present invention contains at least one polarizing plate, the optical film preferably has optical characteristics satisfying the formulae (1-1) and (2-1).

Ap(420)≧1 (1-1)

Ap(450)/Ap(420)≦0.3 (2-1)

In the formulae, Ap(420) represents the absorbance of the optical film at a wavelength of 420 nm in the transmission direction of the polarizing plate and Ap(450) represents the absorbance of the optical film at a wavelength of 450 nm in the transmission direction of the polarizing plate.

When the formulae (1-1) and (2-1) are satisfied, an optical film is obtained which exhibits high selective absorbability to wavelengths around 420 nm and has high blue-light cutting function, ensuring that it can impart good display characteristics when it is incorporated into a display device.

The optical film of the present invention preferably contains at least one retardation film. Here, the retardation film means an optical film exhibiting optical anisotropy and examples of the retardation film include stretched films obtained by stretching polymer films made from, for example, polyvinyl alcohol, polycarbonate, polyester, polyarylate, polyimide, polyolefin, polycycloolefin, polystyrene, polysulfone, polyether sulfone, polyvinylidene fluoride/polymethylmethacrylate, acetyl cellulose, ethylene-vinyl acetate copolymer saponified product, or polyvinyl chloride at a stretch rate of about 1.01 to 6. Among these films, polymer films obtained by uniaxially or biaxially stretching polycarbonate films or cycloolefin type resin films are preferable.

When the optical film of the present invention contains a retardation film, it is preferable to contain a retardation film made to exhibit optical anisotropy by application and orientation of a polymerizable liquid crystal compound from the viewpoint of developing a thinner optical film.

Moreover, when the optical film of the present invention contains a retardation film, the retardation film preferably has reverse wavelength dispersibility. The reverse wavelength dispersibility means the optical characteristics that the inplane retardation amount at a shorter wavelength is larger than that at a longer wavelength and the retardation film preferably satisfies the formulae (6) and (7). Here, Re(λ) represents the inplane retardation amount for light having a wavelength of λ nm.

Re(450)/Re(550)≦1 (6)

1≦Re(630)/Re(550) (7)

When the retardation film has reverse wavelength dispersibility in the optical film of the present invention, this is desirable because this reduces the coloring revel when displaying a black color, and when 0.82≦Re(450)/Re(550)≦0.93 in the formula (6), this is more desirable.

In the optical film of the present invention, the retardation film is preferably a layer (hereinafter referred to as “optically anisotropic layer”) made from a polymer of a polymerizable liquid crystal compound kept in an orientation state. As the polymerizable liquid crystal compound, the structure represented by the formula (B) is preferable in the point that it enables the development of the aforementioned reverse wavelength dispersibility and also in the point that it has a maximum absorption at a wavelength range from 340 nm to 400 nm. The polymerizable liquid crystal compound can absorb short-wavelength UV light and therefore exhibits more sufficient UV absorption characteristics to the display device, as long as it has the structure represented by the formula (B).

L¹-G¹-D¹-Ar-D²-G²-L² (B)

In the formula (B), Ar represents a divalent aromatic group and at least one of a nitrogen atom, oxygen atom, and sulfur atom is contained in the aromatic group.

D¹ and D² each independently represent a single bond, —C(═O)—O—, —C(═S)—O—, —CR⁴R⁵—, —CR⁴R⁵—CR⁶R⁷—, —O—CR⁴R⁵—, —CR⁴R⁵—O—CR⁶R⁷—, —CO—O—CR⁴R⁵—, —O—CO—CR⁴R⁵—, —CR⁴R⁵—O—CO—CR⁶R⁷—, —CR⁴R⁷—CO—O—CR⁶R⁷, or NR⁴—CR⁵R⁶, or CO—NR⁴—, wherein R⁴, R⁵, R⁶, and R⁷ each independently represent a hydrogen atom, a fluorine atom, or an alkyl group having 1 to 4 carbon atoms.

G¹ and G² each independently represent a divalent alicyclic hydrocarbon group having 5 to 8 carbon atoms wherein a methylene group constituting the alicyclic hydrocarbon group is optionally replaced with an oxygen atom, sulfur atom, or NH— and a methine group constituting the alicyclic hydrocarbon group is optionally replaced with a tertiary nitrogen atom.

L¹ and L² each independently represent a monovalent organic group, wherein at least one of L¹ and L² has a polymerizable group.

In the formula (B), the divalent aromatic group represented by Ar is preferably an aromatic group having a heteroring from the viewpoint of developing reverse wavelength dispersibility. Examples of the aromatic group include aromatic groups which contain at least one of a nitrogen atom, oxygen atom, and sulfur atom and have a furan ring, benzofuran ring, pyrrole ring, thiophene ting, pyridine ring, thiazole ring, benzothiazole ring, or phenanthroline ring. Particularly, the aromatic group having a heteroring is more preferably an aromatic group having a benzene ring, thiazole ring, or benzothiazole ring and even more preferably an aromatic group having a benzothiazole ring. Also, a nitrogen atom contained in the aromatic ring of Ar preferably has a π-electron.

The total number N_{π} of π-electrons contained in the aromatic ring is preferably 10 or more, more preferably 12 or more, even more preferably 14 or more, and preferably 30 or less and more preferably 25 or less from the viewpoint of reverse wavelength dispersibility.

In the compound (B), L¹ is preferably a group represented by the formula (B1) and L² is preferably a group represented by the formula (B2).

P¹—F¹—(B¹-A¹)ₖ-E¹- (B1)

P²—F²—(B²-A²)₁-E²- (B2)

In the formulae (B1) and (B2);

B¹, B², E¹, and E² each independently represent —CR⁴R⁵—, —CH₂—CH₂—, —O—, —S—, —CO—O—, —O—CO—O—, —CS—O—, —O—CS—O—, —CO—NR¹—, —O—CH₂—, —S—CH₂—, or a single bond.

A¹ and A² each independently represent a divalent alicyclic hydrocarbon group having 5 to 8 carbon atoms or a divalent aromatic hydrocarbon group having 6 to 18 carbon atoms, wherein a methylene group constituting the alicyclic hydrocarbon group is optionally replaced with an oxygen atom, sulfur atom, or NH— and a methine group constituting the alicyclic hydrocarbon group is optionally replaced with a tertiary nitrogen atom.

k and l each independently represent an integer from 0 to 3.

F¹ and F² independently represent a divalent aliphatic hydrocarbon group having 1 to 12 carbon atoms.

P¹ represents a polymerizable group.

P² represents a hydrogen atom or a polymerizable group.

R⁴ and R⁵ each independently represents a hydrogen atom, a fluorine atom, or an alkyl group having 1 to 4 carbon atoms.

The compound having the structure represented by the formula (B) is preferably a compound (hereinafter referred to as “compound (B-1)” according to the case) represented by the formula (B-1).

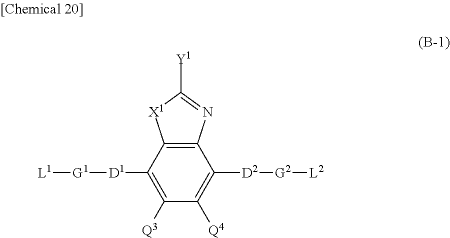

In the formula (B-1);

X¹ represents an oxygen atom, a sulfur atom, or NR¹—. R¹ represents a hydrogen atom or an alkyl group having 1 to 4 carbon atoms;

Y¹ represents a monovalent aromatic hydrocarbon group which has 6 to 12 carbon atoms and may have a substituent or a monovalent aromatic heterocyclic group which has 3 to 12 carbon atoms and may have a substituent;

Q³ and Q⁴ each independently represent a hydrogen atom, a monovalent aliphatic hydrocarbon group which has 1 to 20 carbon atoms and may have a substituent, a monovalent alicyclic hydrocarbon group which has 3 to 20 carbon atoms, a monovalent aromatic hydrocarbon group which has 6 to 20 carbon atoms and may have a substituent, a halogen atom, a cyano group, a nitro group, —NR²R³, or —SR², or Q³ and Q⁴ may be combined to form an aromatic ring or an aromatic heteroring together with carbon atoms where they are combined. R² and R³ each independently represent a hydrogen atom or an alkyl group having 1 to 6 carbon atoms; and

D¹, D², G¹, G², L¹, and L² each independently have the same meanings as those in the formula (B).

Preferable examples of the compound (B-1) include polymerizable liquid crystal compounds described in Japanese Patent National Publication No. 2011-207765.

Examples of other polymerizable liquid crystal compound include compounds having polymerizable group among compounds described in Handbook of Liquid Crystals (edited by Editorial Committee for Handbook of Liquid Crystals, published on Oct. 30 in 2000 by Maruzen Co., Ltd.), “3.8.6 Network (completely crosslinking type)” and “6.5.1 Liquid Crystal Material, b. Polymerizable Nematic Liquid Crystal Material” and polymerizable liquid crystal compounds described in JP-A-2010-31223, JP-A-2010-270108, JP-A-2011-6360, and JP-A-2011-207765.

When a retardation film is produced from a polymer of a polymerizable liquid crystal compound kept in an oriented state, the polymerizable liquid crystal compound or, depending on the situation, a composition (hereinafter also referred to as “composition for forming an optically anisotropic layer”) prepared by diluting the polymerizable liquid crystal compound with a solvent is applied to a substrate or an orientation layer formed on the substrate and polymerized after dried to remove the solvent though depending on the situation, to obtain a polymer of a polymerizable liquid crystal compound kept in an oriented state. The polymerization of the polymerizable liquid crystal compound kept in an oriented state enables the preparation of a liquid crystal cured layer kept in an oriented state and this liquid crystal cured layer constitutes a retardation film.

The content of the polymerizable crystal liquid compound in the retardation film is usually 70 to 99.5 parts by mass, preferably 80 to 99 parts by mass, and more preferably 80 to 94 parts by mass based on 100 parts by mass of the solid content of the composition for forming an optically anisotropic layer from the viewpoint of improving the orientation of the polymerizable liquid crystal compound. “The solid content” in this description means the total amount of components excluding a solvent from the composition for forming an optically anisotropic layer.

The composition for forming an optically anisotropic layer may contain known components such as a solvent, photopolymerization initiator, polymerization inhibitor, photosensitizer, and leveling agent besides the polymerizable liquid crystal compound.

The solvent is preferably an organic solvent capable of dissolving the structural components of the composition for forming an optically anisotropic layer such as the polymerizable liquid crystal compound, and more preferably a solvent which can dissolve the structural components of the composition for forming an optically anisotropic layer such as the polymerizable liquid crystal compound and is inert to the polymerization reaction of the polymerizable liquid crystal compound. Examples of the solvent include water; alcohol solvents such as methanol, ethanol, ethylene glycol, isopropyl alcohol, propylene glycol, methyl cellosolve, butyl cellosolve, propylene glycol monomethyl ether, and phenol; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; non-chlorinated aliphatic hydrocarbon solvents such as pentane, hexane, and heptane; non-chlorinated aromatic hydrocarbon solvents such as toluene and xylene; nitrile solvents such as acetonitrile; ether solvents such as tetrahydrofuran and dimethoxyethane; and chlorinated hydrocarbon solvents such as chloroform and chlorobenzene. Two or more types of organic solvents may be used in combinations. Among these solvents, alcohol solvents, ester solvents, ketone solvents, non-chlorinated aliphatic hydrocarbon solvents, and non-chlorinated aromatic hydrocarbon solvents are preferable.

The content of the solvent is preferably 10 to 10000 parts by mass and more preferably 100 to 5000 parts by mass based on 100 parts by mass of the solid content of the composition for forming an optically anisotropic layer. The solid concentration of the composition for forming an optically anisotropic layer is preferably 2 to 50% by mass and more preferably 5 to 50% by mass.

The photopolymerization initiator is preferably those generating radicals by light irradiation. Examples of the photopolymerization initiator include benzoin compounds, benzophenone compounds, benzylketal compounds, α-hydroxyketone compounds, α-aminoketone compounds, α-acetophenone compounds, triazine compounds, iodonium salts, and sulfonium salts. Specifically, examples of the photopolymerization initiator include Irgacure (trademark) 907, Irgacure 184, Irgacure 651, Irgacure 819, Irgacure 250, and Irgacure 369 (the above products are all manufactured by BASF Japan Ltd.). Among these products, α-acetophenone compounds are preferable.

The photopolymerization initiator has a maximum absorption wavelength of preferably 300 nm to 380 nm and more preferably 300 nm to 360 nm because this ensures efficient utilization of the energy emitted from a light source and high productivity.

The content of the polymerization initiator is usually 0.1 to 30 parts by mass and preferably 0.5 to 10 parts by mass based on 100 parts by mass of the polymerizable liquid crystal compound in order to polymerize the polymerizable liquid crystal compound without disturbing the orientation of the polymerizable liquid crystal compound.

The polymerization inhibitor can control the polymerization reaction of the polymerizable liquid crystal compound. Examples of the polymerization inhibitor include hydroquinone, methoquinone, 3,5-di-tert-butyl-4-hydroxytoluene (BHT), and hydroquinones having a substituent such as alkyl ethers; catechols having a substituent such as alkyl ethers, such as butylcatechol; pyrogallols; radical scavengers such as a 2,2,6,6-tetramethyl-1-piperidinyloxy radical; thiophenols; β-naphthylamines, and β-naphthols.

The content of the polymerization inhibitor is usually 0.1 to 30 parts by mass and preferably 0.5 to 10 parts by mass based on 100 parts by mass of the polymerizable liquid crystal compound in order to polymerize the polymerizable liquid crystal compound without disturbing the orientation of the polymerizable liquid crystal compound.

Examples of the photosensitizer include xanthones such as xanthone and thioxanthone; anthracene and anthracenes having a substituent such as alkyl ethers; phenothiazine; rubrene. The photopolymerization initiator can be highly sensitized by using the photosensitizer. The content of the photosensitizer is usually 0.1 to 30 parts by mass and preferably 0.5 to 10 parts by mass based on 100 parts by mass of the polymerizable liquid crystal compound.

Examples of the leveling agent include organic-modified silicone oil type, polyacrylate type, or perfluoroalkyl type leveling agents. Specifically, examples of the leveling agent include SH7PA, DC11PA, SH28PA, ST80PA, SH8400, and SH8700 (manufactured by Dow Corning Toray Co., Ltd.), KP321, KP323, KP340, and X22-161A (manufactured by Shin-Etsu Chemical Co., Ltd.), TSF400, TSF4440, and TSF4445 (manufactured by Momentive Performance Materials Inc.), Megafac (trademark) R-30, F-445, F-477, and F-483 (manufactured by DIC Corporation), E1830 (trade name), and E5844 (manufactured by Daikin Fine Chemical Research Institute), and BM-1000, BM-1100, BYK-352, BYK-353, and BYK-361N (trade name, manufactured by BM Chemie. Com.). Two or more types of leveling agents may be combined.

The use of the leveling agent enables the formation of an optically anisotropic layer having more smoothness. Also, the use of the leveling agent ensures that in the process of producing the optical film having the optically anisotropic layer, the fluidity of the composition for forming an optically anisotropic layer can be controlled and the crosslinking density of the retardation film can be regulated. The content of the leveling agent is usually 0.1 to 30 parts by mass and preferably 0.1 to 10 parts by mass based on 100 parts by mass of the polymerizable liquid crystal compound.

In the aforementioned optical film, many polarizing plates are used in the condition where a protection film is applied to one or both surfaces of a polarizer constituting the polarizing plate, for example, a polarizer made from a polyvinyl alcohol type resin. Usually, a pressure-sensitive adhesive layer is formed on one of the surfaces. Also, many elliptically polarizing plates each produced by laminating a polarizing plate on a retardation film are put in the condition where a protection film is applied to one or both surfaces of a polarizer. When a pressure-sensitive adhesive layer is formed on such an elliptically polarizing plate, the pressure-sensitive adhesive layer is formed on the retardation film side.

A transparent resin film is used as the protection film and examples of the transparent resin include acetyl cellulose type resins represented by triacetyl cellulose and diacetyl cellulose, methacrylic resins represented by polymethylmethacrylate, polyester resins, polyolefin type resins, polycarbonate resins, polyether ether ketone resins, and polysulfone resins. As the protection film, a film of a resin to which a general UV absorber such as a salicylate type compound, benzophenone type compound, benzotriazole type compound, triazine type compound, cyanoacrylate type compound, and nickel complex salt type compound is added is preferable. When such a protection film is used, a display device is optimally prevented from deterioration caused by ultraviolet rays. As the protection film, an acetyl cellulose type resin film such as a triacetyl cellulose film is preferably used. In this case, the surface of the protection film to which surface of a polarizing plate or a retardation film is not bonded may be provided with a surface treatment layer. For example, the surface of the protection film may be provided with a hard coat layer, antiglare layer, antireflection layer, and antistatic layer.

Also, a protect film which is to be peeled and removed after it is applied to a display device may be applied to a surface reverse to the surface on which the pressure-sensitive adhesive layer of the polarizing plate is formed, for the purpose of protecting the surface of the optical film from damages and dirt.

Also, in the optical film of the present invention, it is preferable to apply a releasable film to the surface of the pressure-sensitive adhesive layer for temporal adhering protection until it is used. The releasable film used here may be one obtained by using, as its substrate, various resins such as polyethylene terephthalate, polybutylene terephthalate, polycarbonate, and polyarylate and by performing release treatment such as silicone treatment on the interface between the substrate and the pressure-sensitive adhesive layer.

The optical film (laminated optical film) of the present invention may be produced by, for example, a method in which a pressure-sensitive adhesive composition as explained above is applied to a releasable film like those mentioned above to form a pressure-sensitive adhesive layer and an optical film is further laminated on the obtained pressure-sensitive adhesive layer or a method in which a pressure-sensitive adhesive composition is applied to an optical film to form a pressure-sensitive adhesive layer and a releasable film is applied to the pressure-sensitive adhesive layer to protect, thereby making a laminated optical film.

The combined thickness of the polarizing plate and pressure-sensitive adhesive layer in the optical film (laminated optical film) of the present invention is preferably 30 to 500 μm, more preferably 30 to 300 μm, and even more preferably 30 to 100 μm from the viewpoint of developing a thinner layer. When the optical film of the present invention contains a retardation film besides a polarizing plate and a pressure-sensitive adhesive layer, the combined thickness of the polarizing plate, pressure-sensitive adhesive layer, and retardation film is preferably 30 to 550 μm, more preferably 30 to 400 μm, and even more preferably 30 to 150 μm. In a preferred embodiment of the present invention, a thin-type optical film formed with no protection film can be provided by formulating a light-selective absorption compound in the pressure-sensitive adhesive layer.

In another embodiment, the present invention provides a display device including the optical film of the present invention. Since the display device of the present invention includes the optical film of the present invention, it exhibits high selective absorbability to a wavelength range around 420 nm and hence has a high blue-light cutting function. Because the display device of the present invention scarcely absorbs light having a wavelength range around 450 nm on the other hand, it is superior in color expression without hindering absorption of light having a wavelength range around 450 nm, making it possible to impart better display characteristics to the display device. It has been necessary so far to built-in or retrofit, for example, a film having a blue-light cutting function to provide a blue-light cutting function to a display device. However, in the optical film of the present invention, the optical film itself has a blue-light cutting function and therefore, this optical film is industrially advantageous in the point of simplifying a process of producing a display device, enabling development of a thinner display device.

### EXAMPLES

The present invention will be explained in more detail by way of examples and comparative examples, in which all designations of “%” and “parts” indicate “% by mass” and “parts by mass”, respectively, unless otherwise noted.

In the following examples, the measurement of weight average molecular weight and number average molecular weight was made by using a GPC device, five columns in total as the column (four columns “TSK gel XL, manufactured by Tosoh Corporation” and one column “Shodex GPC KF-802, manufactured by Showa Denko K.K.”) which were arranged by connecting these columns in series, and tetrahydrofuran as the eluent in the conditions that the concentration of a sample was 5 mg/mL, the amount of a sample to be introduced was 100 μL, the temperature was 40° C., and the flow rate was 1 mL/min, to calculate the results in terms of standard polyethylene.

### <Preparation of Acrylic Resin>

Acrylic resins (A) and (B) were prepared according to the compositions shown in Table 1 by the following method.

### Polymerization Example 1: Preparation of Acrylic Resin (A)

A reaction container equipped with a cooling tube, a nitrogen-introducing tube, a temperature gage, and a stirrer was charged with a mixture solution containing 81.8 parts of ethyl acetate as a solvent, 70.4 parts of butyl acrylate, 20.0 parts of methyl acrylate, and 8.0 parts of 2-phenoxyethyl acrylate as a monomer (A-1), and 1.0 part of 2-hydroxyethyl acrylate and 0.6 parts of acrylic acid as a monomer (A-2) and the inside temperature was raised to 55° C. while replacing the air in the reaction container with nitrogen gas to exclude oxygen. Then, a solution prepared by dissolving 0.14 parts of azobisisobutyronitrile (polymerization initiator) in 10 parts of ethyl acetate was wholly added to the mixture. The mixture was kept at this temperature for 1 hour after the initiator was added and then, ethyl acetate was successively added in the reaction container at a rate of 17.3 parts/hour while keeping the inside temperature of 54 to 56° C. The addition of ethyl acetate was stopped when the concentration of acrylic resin was 35% and the mixture was kept at this temperature until 12 hours passed since the addition of ethyl acetate was started. Finally, the concentration of acrylic resin was adjusted to 20% by addition of ethyl acetate to prepare an ethyl acetate solution of acrylic resin. The obtained acrylic resin had a weight average molecular weight (Mw) of 1420000 in terms of polystyrene and had a molecular weight distribution (Mw/Mn) of 5.2 as measured by GPC. This acrylic resin was named an acrylic resin (A).

### Polymerization Example 2: Preparation of Acrylic Resin (B)

A reaction container equipped with a cooling tube, a nitrogen-introducing tube, a temperature gage, and a stirrer was charged with a mixture solution containing 81.8 parts of ethyl acetate as a solvent, 96.0 parts of butyl acrylate as a monomer (A-1), and 4.0 parts of acrylic acid as a monomer (A-2) and the inside temperature was raised to 55° C. while replacing the air in the reaction container with nitrogen gas to exclude oxygen. Then, a solution prepared by dissolving 0.14 parts of azobisisobutyronitrile (polymerization initiator) in 10 parts of ethyl acetate was wholly added to the mixture. The mixture was kept at this temperature for 1 hour after the initiator was added and then, ethyl acetate was successively added in the reaction container at a rate of 17.3 parts/hour while keeping the inside temperature of 54 to 56° C. The addition of ethyl acetate was stopped when the concentration of acrylic resin was 35% and the mixture was kept at this temperature until 12 hours passed since the addition of ethyl acetate was started. Finally, the concentration of acrylic resin was adjusted to 20% by addition of ethyl acetate to prepare an ethyl acetate solution of acrylic resin. The obtained acrylic resin had a weight average molecular weight (Mw) of 756000 in terms of polystyrene and had a molecular weight distribution (Mw/Mn) of 4.1 as measured by GPC. This acrylic resin was named an acrylic resin (B).

TABLE 1

| | | | | | | | | Molecular |
|---|---|---|---|---|---|---|---|---|
| | | Monomer composition (parts by mass) | | | | | Molecular | weight |
| | Acrylic | (A-1) | | | (A-2) | | weight | distribution |
| | resin | BA | MA | PEA | HEA | AA | (Mw) | (Mw/Mn) |
| Polymerization | A | 70.4 | 20.0 | 8.0 | 1.0 | 0.6 | 1420000 | 5.2 |
| Example 1 | | | | | | | | |
| Polymerization | B | 98.0 | — | — | — | 4.0 | 756000 | 4.1 |
| Example 2 | | | | | | | | |

In Table 1, the symbols in the column of the monomer composition mean the following monomers respectively.

### Monomer (A-1)

BA: Butyl acrylate

MA: Methyl acrylate

PEA: 2-phenoxyethyl acrylate

### Monomer (A-2)

HEA: 2-Hydroxyethyl acrylate

AA: Acrylic acid

The acrylic resins prepared above were used to prepare pressure-sensitive adhesive compositions, which were then used to manufacture optical films of examples and comparative examples. The following compounds were used as a crosslinking agent, silane compound, and light-selective absorption compound respectively.

### Crosslinking Agent (B)

Coronate L: an ethyl acetate solution of a trimethylolpropane adduct of tolylene diisocyanate (solid concentration: 75%), manufactured by Nippon Polyurethane Co., Ltd.

Takenate D-110N: an ethyl acetate solution of a trimethylolpropane adduct of xylylene diisocyanate (solid concentration: 75%), manufactured by Mitsui Chemicals, Inc., (hereinafter abbreviated as “D110N”)

### Silane Compound

KBM-403: 3-glycidoxypropyltrimethoxysilane, liquid, manufactured by Shin-Etsu Chemical Co., Ltd., (hereinafter abbreviated as “KBM-403”)

### Light-Selective Absorption Compound

S0511: manufactured by FEW Chemicals GmbH, λmax=392 nm, ç(420)=3.2 L/(g·cm), ε(450)=0 L/(g·cm) (in 2-butanone)

### <Synthesis of a Light-Selective Absorption Compound>

### Synthesis Example 1

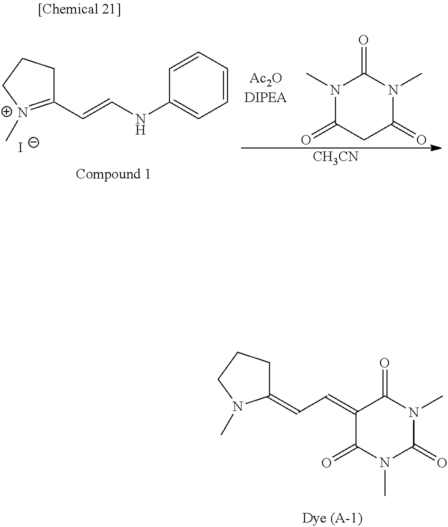

A 100 mL-four-neck flask equipped with a Dimroth cooling tube and a temperature gage, in which the inside atmosphere was replaced with a nitrogen atmosphere, was charged with 10 g of powder of a compound 1 synthesized with reference to Patent Document (JP-A-2014-194508), 3.6 g of acetic acid anhydride (manufactured by Wako Pure Chemical Industries, Ltd.), 5.5 g of 1, 3-dimethylbarbituric acid (manufactured by Tokyo Chemical Industry Co., Ltd.), and 30 g of acetonitrile and the mixture was stirred by a magnetic stirrer. To the mixture, 4.5 g of N,N-diisopropylethylamine (hereinafter abbreviated as DIPEA, manufactured by Tokyo Chemical Industry Co., Ltd.) was added dropwise from a dropping funnel for 1 hour and the resulting mixture was kept at 25° C. for further 2 hours after the addition was finished. The precipitated sediment was collected by filtration and the obtained wet crystals were washed six times with 150 g of pure water. The obtained crystals were dried at 70° C. under reduced pressure to obtain 6.1 g of a dye (A-1) as yellow powder. The yield was 76%.

Also, maximum absorption wavelength (λmax) was measured using a spectrophotometer UV-3150 (manufactured by Shimadzu Corporation), to find that λmax=410 nm (in 2-butanone), the value of ε(420) was 221 L/(g·cm), and the value of ε(450)/ε(420) was 0.012.

As a result of ¹H-NMR analysis, the following peaks were observed, to thereby confirm that the dye (A-1) was produced. ¹H-NMR (DMSO-d₆) δ(ppm): 2.15 (quin, 2H), 3.17-3.26 (m, 5H), 3.30 (s, 6H), 3.76 (t, 2H), 7.25 (d, 1H), 8.18 (d, 1H)

### Synthetic Example 2

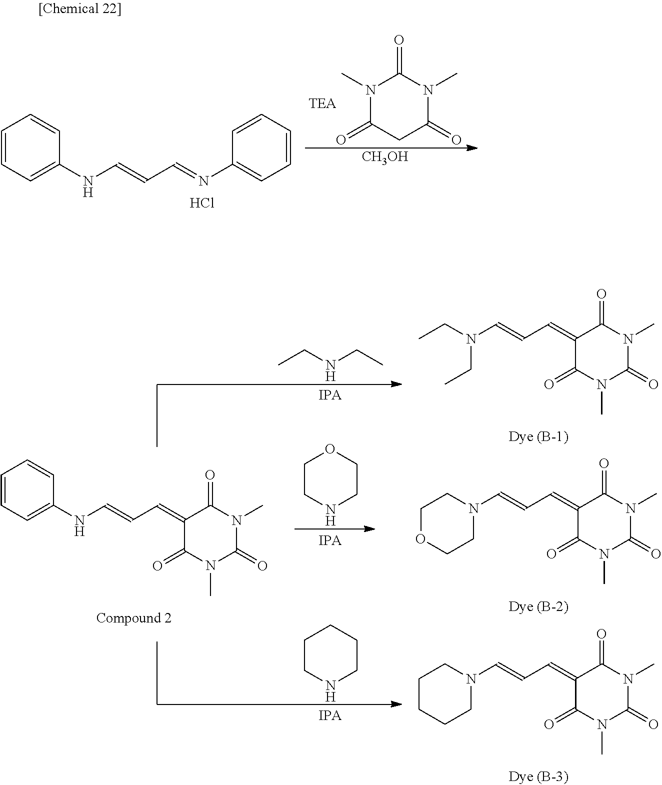

A 300 mL-four-neck flask equipped with a Dimroth cooling tube, a temperature gage, and a stirrer, in which the inside atmosphere was replaced with a nitrogen atmosphere, was charged with 20 g of malonaldehyde dianilide hydrochloride (manufactured by Tokyo Chemical Industry Co., Ltd.), 13.3 g of 1,3-dimethylbarbituric acid (manufactured by Tokyo Chemical Industry Co., Ltd.), and 46 g of methanol to start stirring at ambient temperature. To the mixture, 8.6 g of triethylamine (manufactured by Wako Pure Chemical Industries, Ltd.) was added dropwise from a dropping funnel for 30 minutes to continue stirring at ambient temperature for 1 hour. Then, the inside temperature was raised to 65° C. by using an oil bath to undergo boiling reflux for 1 hour. The inside temperature was cooled to ambient temperature after the reaction was completed, the precipitated crystals were collected by filtration, and the obtained wet crystals were washed with methanol. The wet crystals after being washed were dried at 40° C. under reduced pressure to obtain 18.5 g of a compound 2 as orange powder. The yield was 84%.

As a result of ¹H-NMR analysis, the following peaks were observed, to thereby confirm that the compound 2 was produced. ¹H-NMR (DMSO-d₆) δ(ppm): 3.07 (s, 6H), 7.04-7.07 (m, 1H), 7.26-7.32 (m, 4H), 7.43 (dd, 1H), 8.07 (d, 1H), 8.55 (d, 1H), 11.4 (s, 1H)

### Synthetic Example 3

A 100 mL-four-neck flask equipped with a Dimroth cooling tube and a temperature gage, in which the inside atmosphere was replaced with a nitrogen atmosphere, was charged with 2.0 g of powder of a compound 2, 1.4 g of diethylamine (manufactured by Tokyo Chemical Industry Co., Ltd.) and 10 g of 2-propanol (manufactured by NACALAI TESQUE, INC.) and the mixture was stirred by a magnetic stirrer. The mixture was heated using an oil bath and then, kept at 52° C. for 5 hours. The resulting mixture was cooled to ambient temperature after the reaction was completed. Using a vacuum evaporator, 2-propanol was removed and the obtained oily product was subjected to column chromatography (silica gel) to purify, thereby obtaining 1.1 g of a dye (B-1) as orange powder. The yield was 58%. Also, maximum absorption wavelength (λmax) was measured using a spectrophotometer UV-3150 (manufactured by Shimadzu Corporation), to find that λmax=404 nm (in 2-butanone), the value of ε(420) was 80.6 L/(g·cm), and the value of ε(450)/ε(420) was 0.011.

As a result of ¹H-NMR analysis, the following peaks were observed, to thereby confirm that the dye (B-1) was produced. ¹H-NMR (CDCl3) δ(ppm): 1.26-1.37 (m, 6H), 3.34 (s, 3H), 3.35 (s, 3H), 3.43-3.56 (m, 4H), 7.27-7.39 (m, 2H), 8.04 (d, 1H)

### Synthetic Example 4

A 100 mL-four-neck flask equipped with a Dimroth cooling tube and a temperature gage, in which the inside atmosphere was replaced with a nitrogen atmosphere, was charged with 2.0 g of powder of a compound 2, 1.6 g of morpholine (manufactured by Wako Pure Chemical Industries, Ltd.), and 10 g of 2-propanol (manufactured by NACALAI TESQUE, INC.) and the mixture was stirred by a magnetic stirrer. The mixture was heated using an oil bath to undergo boiling reflux at 83° C. for 3 hours. The resulting mixture was cooled to ambient temperature after the reaction was completed. The precipitated crystals were collected by filtration and the wet crystals were washed four times with 2-propanol. Then, the obtained crystals were dried at 40° C. under reduced pressure to obtain 1.6 g of a dye (B-2) as orange powder. The yield was 82%.

Also, maximum absorption wavelength (λmax) was measured using a spectrophotometer UV-3150 (manufactured by Shimadzu Corporation), to find that λmax=406 nm (in 2-butanone), the value of ε(420) was 102 L/(g·cm), and the value of ε(450)/ε(420) was 0.004.

As a result of ¹H-NMR analysis, the following peaks were observed, to thereby confirm that the dye (B-2) was produced. ¹H-NMR (CDCl3) δ(ppm): 3.27 (s, 3H), 3.29 (s, 3H), 3.50-3.59 (m, 4H), 3.72-3.78 (m, 4H), 7.19-7.32 (m, 2H), 7.95-8.06 (m, 1H)

### Synthetic Example 5

A 100 mL-four-neck flask equipped with a Dimroth cooling tube and a temperature gage, in which the inside atmosphere was replaced with a nitrogen atmosphere, was charged with 2.0 g of powder of a compound 2, 1.6 g of piperidine (manufactured by Wako Pure Chemical Industries, Ltd.), and 10 g of 2-propanol (manufactured by NACALAI TESQUE, INC.) and the mixture was stirred by a magnetic stirrer. The mixture was heated using an oil bath to undergo boiling reflux at 83° C. for 3 hours. The resulting mixture was cooled to ambient temperature after the reaction was completed. The precipitated crystals were collected by filtration and the wet crystals were washed four times with 2-propanol. Then, the obtained crystals were dried at 40° C. under reduced pressure to obtain 1.7 g of a dye (B-3) as orange powder. The yield was 85%.

Also, maximum absorption wavelength (λmax) was measured using a spectrophotometer UV-3150 (manufactured by Shimadzu Corporation), to find that λmax=404 nm (in 2-butanone), the value of ε(420) was 84.5 L/(g·cm), and the value of ε(450)/ε(420) was 0.004.

As a result of ¹H-NMR analysis, the following peaks were observed, to thereby confirm that the dye (B-3) was produced. ¹H-NMR (CDCl3) δ(ppm): 1.72-1.74 (m, 6H), 3.32 (s, 3H), 3.33 (s, 3H), 3.49-3.61 (m, 4H), 7.28-7.37 (m, 2H), 7.98-8.09 (m, 1H)

### Synthetic Example 6

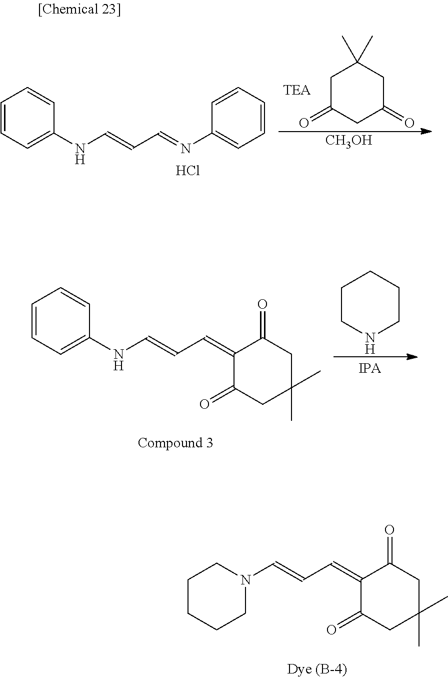

A 300 mL-four-neck flask equipped with a Dimroth cooling tube, a temperature gage, and a stirrer, in which the inside atmosphere was replaced with a nitrogen atmosphere, was charged with 20 g of malonaldehyde dianilide hydrochloride (manufactured by Tokyo Chemical Industry Co., Ltd.), 11.9 g of dimedone (manufactured by Tokyo Chemical Industry Co., Ltd.), and 46 g of methanol to start stirring at ambient temperature. To the mixture, 8.6 g of triethylamine (manufactured by Wako Pure Chemical Industries, Ltd.) was added dropwise from a dropping funnel for 30 minutes to continue stirring at ambient temperature for 1 hour. Then, the inside temperature was raised to 65° C. by using an oil bath to undergo boiling reflux for 1 hour. The inside temperature was cooled to ambient temperature after the reaction was completed, the precipitated crystals were collected by filtration, and the obtained wet crystals were washed with methanol. The wet crystals after washed were dried at 40° C. under reduced pressure to obtain 17.7 g of a compound 3 as orange powder. The yield was 85%.

As a result of ¹H-NMR analysis, the following peaks were observed, to thereby confirm that the compound 3 was produced. ¹H-NMR (DMSO-d₆) δ(ppm): 0.95 (s, 6H), 2.30 (s, 4H), 7.08-7.13 (m, 1H), 7.30-7.40 (m, 4H), 7.53 (dd, 1H), 7.91 (d, 1H), 8.51 (d, 1H), 11.2 (s, 1H)

### Synthetic Example 7

A 100 mL-four-neck flask equipped with a Dimroth cooling tube and a temperature gage, in which the inside atmosphere was replaced with a nitrogen atmosphere, was charged with 3.0 g of powder of a compound 3, 2.5 g of piperidine (manufactured by Wako Pure Chemical Industries, Ltd.), and 15 g of 2-propanol (manufactured by NACALAI TESQUE, INC.) and the mixture was stirred by a magnetic stirrer. The mixture was heated using an oil bath to undergo boiling reflux at 83° C. for 3 hours. The resulting mixture was cooled to ambient temperature after the reaction was completed. The precipitated crystals were collected by filtration and the wet crystals were washed twice with 2-propanol. Then, the obtained crystals were dried at 40° C. under reduced pressure to obtain 0.9 g of a dye (B-4) as orange powder. The yield was 31%.

Also, maximum absorption wavelength (λmax) was measured using a spectrophotometer UV-3150 (manufactured by Shimadzu Corporation), to find that λmax=413 nm (in 2-butanone), the value of ε(420) was 238 L/(g·cm), and the value of ε(450)/ε(420) was 0.009.

As a result of ¹H-NMR, the following peaks were observed, to thereby confirm that the dye (B-4) was produced. ¹H-NMR (CDCl3) δ(ppm): 1.04 (s, 6H), 1.69-1.73 (m, 6H), 2.39 (d, 4H), 3.48-3.58 (m, 4H), 7.32-7.45 (m, 2H), 7.88 (d, 1H)

### Synthetic Example 8

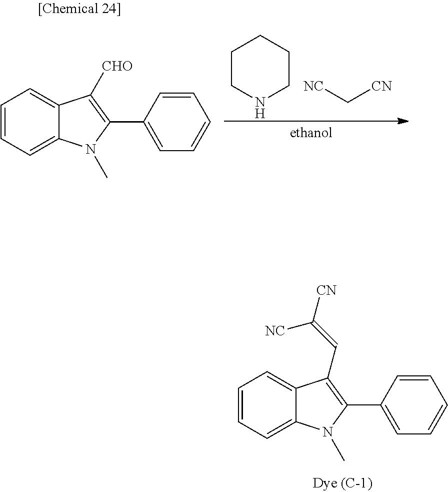

A 100 mL-four-neck flask equipped with a Dimroth cooling tube and a temperature gage, in which the inside atmosphere was replaced with a nitrogen atmosphere, was charged with 5.0 g of 2-phenyl-1-methylindole-3-carboxyaldehyde, 1.8 g of piperidine (manufactured by Wako Pure Chemical Industries, Ltd.), 1.5 g of malononitrile (manufactured by Tokyo Chemical Industry Co., Ltd.), and 20 g of ethanol (manufactured by Wako Pure Chemical Industries, Ltd.) and the mixture was stirred by a magnetic stirrer. The mixture was heated using an oil bath and kept at 80° C. for 18 hr. The resulting mixture was cooled to ambient temperature after the reaction was completed. The precipitated crystals were collected by filtration and the crystals were dried at 60° C. under reduced pressure to obtain 4.9 g of a dye (C-1) as yellow powder. The yield was 82%.

Also, maximum absorption wavelength (?max) was measured using a spectrophotometer UV-3150 (manufactured by Shimadzu Corporation), to find that λmax=392 nm (in 2-butanone), the value of ε(420) was 23.9 L/(g·cm), and the value of ε(450)/ε(420) was 0.007.

As a result of ¹H-NMR analysis, the following peaks were observed, to thereby confirm that the dye (C-1) was produced. ¹H-NMR (CDCl3) δ(ppm): 3.71 (s, 3H), 7.34-7.38 (m, 2H), 7.44-7.47 (m, 4H), 7.60-7.63 (m, 3H), 8.37-8.40 (m, 1H)

### Synthetic Example 9

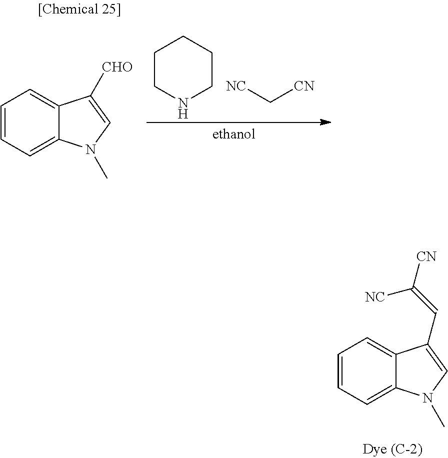

A 100 mL-four-neck flask equipped with a Dimroth cooling tube and a temperature gage, in which the inside atmosphere was replaced with a nitrogen atmosphere, was charged with 1.0 g of l-methylindole-3-carboxyaldehyde, 0.53 g of piperidine (manufactured by Wako Pure Chemical Industries, Ltd.), 0.46 g of malononitrile (manufactured by Tokyo Chemical Industry Co., Ltd.), and 4 g of ethanol (manufactured by Wako Pure Chemical Industries, Ltd.) and the mixture was stirred by a magnetic stirrer. The mixture was heated using an oil bath to undergo boiling reflux at 78° C. for 18 hours. The resulting mixture was cooled to ambient temperature after the reaction was completed. The precipitated crystals were collected by filtration and the crystals were dried at 60° C. under reduced pressure to obtain 0.96 g of a dye (C-2) as yellow powder. The yield was 74%.

Also, maximum absorption wavelength (λmax) was measured using a spectrophotometer UV-3150 (manufactured by Shimadzu Corporation), to find that λmax=392 nm (in 2-butanone), the value of ε(420) was 48.4 L/(g·cm), and the value of ε(450)/ε(420) was 0.004.

As a result of ¹H-NMR analysis, the following peaks were observed, to thereby confirm that the dye (C-2) was produced. ¹H-NMR (CDCl3) δ(ppm): 3.95 (s, 3H), 7.26-7.44 (m, 4H), 7.71-7.75 (m, 1H), 8.03 (s, 1H), 8.43 (s, 1H)

### <Preparation of Pressure-Sensitive Adhesive Compositions and Pressure-Sensitive Adhesive Sheets (Optical Film)>

### (a) Preparation of Pressure-Sensitive Adhesive Compositions

### Production Examples 1 to 18

An acrylic resin, light-selective absorption composition, crosslinking agent, and silane compound described in Table 2 shown below were mixed to produce pressure-sensitive adhesive compositions. In this case, the amount of each component is parts by mass based on 100 parts by mass of the solid content in the acrylic resin manufactured in the above Polymerization Examples 1 and 2. Also, the crosslinking agent and light-selective absorption compound were each added in the form of a 2-butanone solution to the acrylic resin.

(a-1) Preparation of Pressure-Sensitive Adhesive Compositions of Production Examples 1 to 9

A crosslinking agent, silane compound, and light-selective absorption compound were formulated in the amounts shown in Table 2 respectively based on 100 parts by mass of the solid content of the acrylic resin (A). Then, 2-butanone was added to the mixture in such an amount that the solid concentration was 14% and then, the mixture was mixed at 300 rpm with stirring for 30 minutes using a stirrer (Three-One-Motor, manufactured by YAMATO POLYMER CO., LTD.) to thereby prepare each pressure-sensitive adhesive composition.

(a-2) Preparation of Pressure-Sensitive Adhesive Compositions of Production Examples 10 to 18

Each pressure-sensitive adhesive composition was prepared in the same method as in the Production Examples 1 to 9 according to the formulations shown in Table 2 except that the acrylic resin (A) was altered to the acrylic resin (B).

TABLE 2

| | | Light-selective | | | | | |
|---|---|---|---|---|---|---|---|
| | | absorption compound | | Crosslinking agent | | Silane compound | |
| | Acrylic | | Amount | | Amount | | Amount |
| | resin | Name | (parts) | Name | (parts) | Name | (parts) |
| Production | A | Dye (A-1) | 0.61 | Coronate L | 0.50 | KBM-403 | 0.50 |
| Example 1 | | | | | | | |
| Production | A | Dye (B-1) | 1.2 | Coronate L | 0.50 | KBM-403 | 0.50 |
| Example 2 | | | | | | | |
| Production | A | Dye (B-2) | 1.3 | Coronate L | 0.50 | KBM-403 | 0.50 |
| Example 3 | | | | | | | |
| Production | A | Dye (B-3) | 1.6 | Coronate L | 0.50 | KBM-403 | 0.50 |
| Example 4 | | | | | | | |
| Production | A | Dye (B-4) | 0.58 | Coronate L | 0.50 | KBM-403 | 0.50 |
| Example 5 | | | | | | | |
| Production | A | Dye (C-1) | 5.6 | Coronate L | 0.50 | KBM-403 | 0.50 |
| Example 6 | | | | | | | |
| Production | A | Dye (C-2) | 2.8 | Coronate L | 0.50 | KBM-403 | 0.50 |
| Example 7 | | | | | | | |
| Production | A | S0511 | 10 | Coronate L | 0.50 | KBM-403 | 0.50 |
| Example 8 | | | | | | | |
| Production | A | None | | Coronate L | 0.50 | KBM-403 | 0.50 |
| Example 9 | | | | | | | |
| Production | B | Dye (A-1) | 0.61 | Coronate L | 0.50 | KBM-403 | 0.50 |
| Example 10 | | | | | | | |
| Production | B | Dye (B-1) | 1.2 | Coronate L | 0.50 | KBM-403 | 0.50 |
| Example 11 | | | | | | | |
| Production | B | Dye (B-2) | 1.3 | Coronate L | 0.50 | KBM-403 | 0.50 |
| Example 12 | | | | | | | |
| Production | B | Dye (B-3) | 1.6 | Coronate L | 0.50 | KBM-403 | 0.50 |
| Example 11 | | | | | | | |
| Production | B | Dye (B-4) | 0.58 | Coronate L | 0.50 | KBM-403 | 0.50 |
| Example 14 | | | | | | | |
| Production | B | Dye (C-1) | 5.6 | Coronate L | 0.50 | KBM-403 | 0.50 |
| Example 15 | | | | | | | |
| Production | B | Dye (C-2) | 2.8 | Coronate L | 0.50 | KBM-403 | 0.50 |
| Example 16 | | | | | | | |
| Production | B | S0511 | 10 | Coronate L | 0.50 | KBM-403 | 0.50 |
| Example 17 | | | | | | | |

| | | | | | | |
|---|---|---|---|---|---|---|
| Production | B | None | Coronate L | 0.50 | KBM-403 | 0.50 |
| Example 18 | | | | | | |

### (b) Production of Pressure-Sensitive Adhesive Sheets Example 1

The pressure-sensitive adhesive composition prepared in Production Example 1 of the above (a) was applied to the releasably treated surface of a polyethylene terephthalate film (SP-PLR382050, manufactured by Lintec Corporation, hereinafter abbreviated as “separator”) by an applicator such that the thickness of the dried pressure-sensitive adhesive layer was 20 μm, followed by drying at 100° C. for 1 minute to prepare a pressure-sensitive adhesive sheet.

The optical characteristics of the obtained pressure-sensitive adhesive sheet were measured by a spectrophotometer (UV-3150, manufactured by Shimadzu Corporation). The results are shown in Table 3. In the table, A(420) indicates absorbance at a wavelength of 420 nm, T(420) indicates a transmittance (%) at a wavelength of 420 nm, A(450) indicates absorbance at a wavelength of 450 nm, and T(450) indicates a transmittance (%) at a wavelength of 450 nm.

### Examples 2 to 14 and Comparative Examples 1 to 4

Pressure-sensitive adhesive sheets of Examples 2 to 14 and Comparative Examples 1 to 4 were prepared in the same manner as in Example 1 by using the pressure-sensitive adhesive compositions prepared in Production Examples 2 to 18 and the optical characteristics of the obtained pressure-sensitive adhesive sheets were measured in the same manner as in Example 1. The results are shown in Table 3.

TABLE 3

| | | Optical characteristics or optical film | | | | |
|---|---|---|---|---|---|---|
| | | (pressure-sensitive adhesive sheet) | | | | |
| | Pressure- | | | A | | |
| | sensitive | | | (450)/ | | |
| | adhesive | A | A | A | T | T |
| | composition | (420) | (450) | (420) | (420) | (450) |
| Example 1 | Production | 2.9 | 0.02 | 0.007 | 0.13 | 90 |
| | Example 1 | | | | | |
| Example 2 | Production | 2.8 | 0.02 | 0.008 | 0.15 | 90 |
| | Example 2 | | | | | |
| Example 3 | Production | 2.8 | 0.02 | 0.007 | 0.15 | 90 |
| | Example 3 | | | | | |
| Example 4 | Production | 2.9 | 0.01 | 0.004 | 0.13 | 93 |
| | Example 4 | | | | | |
| Example 5 | Production | 3.0 | 0.03 | 0.010 | 0.11 | 89 |
| | Example 5 | | | | | |
| Example 6 | Production | 2.7 | 0.03 | 0.011 | 0.18 | 89 |
| | Example 6 | | | | | |
| Example 7 | Production | 2.8 | 0.01 | 0.004 | 0.14 | 93 |
| | Example 7 | | | | | |
| Example 8 | Production | 2.9 | 0.02 | 0.007 | 0.13 | 90 |
| | Example 8 | | | | | |
| Example 9 | Production | 2.8 | 0.02 | 0.007 | 0.15 | 90 |
| | Example 9 | | | | | |
| Example 10 | Production | 2.8 | 0.03 | 0.011 | 0.16 | 88 |
| | Example 10 | | | | | |
| Example 11 | Production | 2.8 | 0.01 | 0.004 | 0.16 | 93 |
| | Example 11 | | | | | |
| Example 12 | Production | 3.0 | 0.02 | 0.007 | 0.10 | 91 |
| | Example 12 | | | | | |
| Example 13 | Production | 2.8 | 0.02 | 0.007 | 0.16 | 91 |
| | Example 13 | | | | | |
| Example 14 | Production | 2.7 | 0.01 | 0.004 | 0.20 | 93 |
| | Example 14 | | | | | |
| Comparative | Production | 0.63 | 0 | — | 23 | 93 |
| Example 1 | Example 15 | | | | | |
| Comparative | Production | 0.62 | 0 | — | 24 | 93 |
| Example 2 | Example 16 | | | | | |
| Comparative | Production | 0.002 | 0.001 | 0.5 | 93 | 93 |
| Example 3 | Example 17 | | | | | |
| Comparative | Production | 0.002 | 0.001 | 0.5 | 93 | 93 |
| Example 4 | Example 18 | | | | | |

With regard to each pressure-sensitive adhesive sheet of Examples 1 to 14, the value of A(420) was 1 or more and the value of A(450)/A(420) was 0.3 or less, showing that each sheet had a good transmittance at a wavelength of 450 nm while it had a high blue-light cutting function. With regard to each pressure-sensitive adhesive sheet of Comparative Examples 1 and 2, on the other hand, the value of A(420) was less than 1 and it was therefore clarified that each sheet of Comparative Examples was inferior in light absorption at a wavelength of 420 nm and in blue-light cutting effect. Also, in each pressure-sensitive adhesive sheet of Comparative Examples 3 and 4, the light-selective absorption compound was not used and therefore had no blue-light cutting function.

### <Production of Optical Films (Laminated Optical Films) (Examples 15 to 28 and Comparative Examples 5 to 8)>

In the production of the optically anisotropic layer, laminated optical film, and the like, the following “Composition for forming a photo-orientation layer”, “Rubbing orientation polymer composition”, “Composition containing a polymerizable liquid crystal compound”, and “Polarizing plate” were used.

### <Preparation of Composition for Forming a Photo-Orientation Layer>

As the components, 5 parts of a photo-orientation material having the following structure and 95 parts of cyclopentanone (solvent) were mixed, and the obtained mixture was stirred at 80° C. for 1 hour to obtain a composition for forming a photo-orientation layer. The following photo-orientation material was synthesized according to the method described in JP-A-2013-33248.

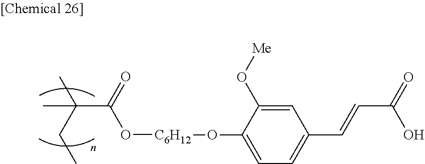

### <Preparation of Composition a Containing a Polymerizable Liquid Crystal Compound>

A polymerizable liquid crystal compound A having the following structure, a polyacrylate compound (leveling agent), the following polymerizable initiator, and the solvent were mixed as the components to obtain a composition A containing a polymerizable liquid crystal compound.

Polymerizable liquid crystal compound A (12.0 parts):

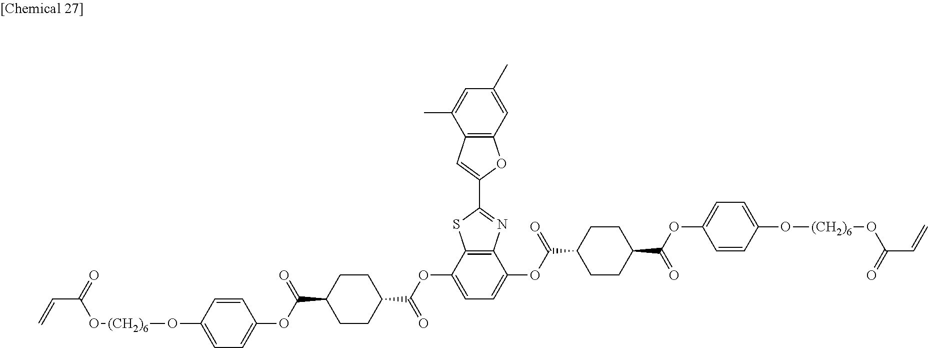

The polymerizable liquid crystal compound A was synthesized according to the method described in JP-A-2011-207765. The maximum absorption wavelength λmax (LC) of the polymerizable liquid crystal compound A was 350 nm.

Polymerization initiator (0.72 parts): 2-dimethylamino-2-benzyl-1-(4-morpholinophenyl)butane-1-one (Irgacure 369; manufactured by BASF Japan Ltd.)

Leveling agent (0.12 parts): Polyacrylate compound (BYK-361N; manufactured by BYK-Chemie. Com.)

Solvent: Cyclopentanone (100 parts)

### Example 15

### <Production of Polarizing Plate>

A polyvinyl alcohol film (average polymerization degree: about 2400, degree of saponification: 99.9 mol % or more) having a thickness of 30 μm was uniaxially stretched at a stretch ratio of 4 by dry stretching. The stretched film was further dipped in 40° C. pure water for 40 seconds with keeping its tensional state and then, dipped at 28° C. in an aqueous dye solution containing iodine/potassium iodide/water in a ratio by weight of 0.044/5.7/100 for 30 seconds to perform dyeing treatment. Then, the film was dipped at 70° C. in an aqueous boric acid solution containing potassium iodide/boric acid/water in a ratio by weight of 11.0/6.2/100 for 120 seconds. In succession, the film was washed with 8° C. pure water for 15 seconds and then, dried at 60° C. for 50 seconds and then, at 75° C. for 20 seconds with keeping it under a tension of 300 N to obtain a 12-μm-thick polarizer in which iodine was adsorbed to and oriented on a polyvinyl alcohol film.

An aqueous adhesive was injected into a space between the obtained polarizer and a cycloolefin polymer film (COP; ZF-4, manufactured by Zeon Corporation, non-UV absorption ability, 30 μm) to laminate the both by a nip roll with the aqueous adhesive disposed therebetween. The obtained laminate was dried at 60° C. for 2 minutes with keeping it under a tension of 430 N/m to obtain a 42-μm-thick polarizing plate formed with a cycloolefin film on one side thereof as a protection film. In this case, the above aqueous adhesive was prepared by adding 3 parts of carboxyl group-modified polyvinyl alcohol (KURARAY POVAL KL318, manufactured by Kuraray Co., Ltd.) and 1.5 parts of a water-soluble polyamide epoxy resin (Sumirez Resin 650, manufactured by Sumika Chemtex Co., Ltd., aqueous solution having a solid concentration of 30%) in 100 parts of water.

The degree of polarization Py and unit transmittance Ty of the obtained polarizing plate were measured in the following manner.

The unit transmittance (T¹) in the direction of the transmission axis and the unit transmittance (T²) in the direction of the absorption axis were measured using an apparatus prepared by setting a folder with a polarizer to a spectrophotometer (UV-3150, manufactured by Shimadzu Corporation) in a wavelength range from 380 to 680 nm with a 2-nm step according to a double beam method. The unit transmittance and degree of polarization at each wavelength were calculated using the formulae (p) and (q) and further, these results were corrected by luminous correction using 2° visual field (C light source) according to JIS Z8701 to calculate a luminous transmittance (Ty) of luminous correction and luminous degree of polarization (Py) of luminous correction. As a result, an absorption type polarizing plate was obtained which had the luminous transmittance (Ty) of 43.0% and the luminous degree of polarization (Py) of 99.99%.

Unit transmittance Ty(%)={(T¹+T²)/2}×100 (p)

Degree of polarization Py(%)={(T¹−T²)/(T¹+T²)}×100 (q)

### <Production of Optically Anisotropic Layer>

A cycloolefin polymer film (COP; ZF-14, manufactured by Zeon Corporation) was treated once in the condition of an output of 0.3 kW and treating speed of 3 m/min by using a corona treatment device (AGF-B10 manufactured by Kasuga Electric Works Ltd.). A composition for forming a photo-orientation film was applied to the corona-treated surface by a bar coater and dried at 80° C. for 1 minute to perform polarizing UV exposure treatment at an integral dose of 100 mJ/cm² by using a polarized UV irradiation device (SPOT CURE SP-7; manufactured by USHIO INC.). The film thickness of the obtained orientation film was measured by an ellipsometer (Ellipsometer M-220, manufactured by JASCO Corporation), to find that it was 100 nm.

In succession, a coating solution including a composition A containing the previously prepared polymerizable liquid crystal compound was applied to the orientation layer by using a bar coater and dried at 120° C. for 1 minute. Then, the orientation layer was irradiated with ultraviolet rays (in a nitrogen atmosphere, integral dose at a wavelength of 313 nm: 500 mJ/cm²) from the surface to which the composition containing the polymerizable liquid crystal compound was applied, by using a high-pressure mercury lamp (Unicure VB-15201BY-A, manufactured by USHIO INC.) to form an optical film containing an optically anisotropic layer 1. The obtained optically anisotropic layer 1 was measured by a laser microscope (LEXT OLS3000, manufactured by Olympus Corporation), to find that it was 2 μm.

After the pressure-sensitive adhesive sheet 1 was applied to the optically anisotropic layer 1 side surface of the obtained optical film, it was applied to the polarizing plate which was treated once in the condition of an output of 0.3 kW and treating speed of 3 m/min by using a corona treatment device (AGF-B10 manufactured by Kasuga Electric Works Ltd.). At this time, the optical film was laminated in such a manner that the slow axis of the optically anisotropic layer formed an angle of 450 with the absorption axis of the polarizing plate to make a circularly polarizing plate. After that, the substrate COP film was peeled off to thereby obtain an optical film 1 (circularly polarizing plate 1) with the polarizing plate to which the optically anisotropic layer 1 was transferred. The thickness of the optical film 1 was 64 μm.

The optical film 1 was transferred to glass to thereby make a measurement sample with the intention of measuring the optical characteristics of the optical film 1. The retardation amounts of the sample at wavelengths of 450 nm, 550 nm, and 630 nm were measured by a birefringence measurement device (KOBRA-WR, manufactured by Oji Scientific Instruments) and the absorbances at wavelengths of 420 nm and 450 nm were measured by a spectral photometer (UV-3150; manufactured by Shimadzu Corporation). In this case, a polarizing prism was disposed on the light source side to make completely linearly polarized light and the measurement sample was irradiated with this linearly polarized light to accomplish measurement. At this time, the linearly polarized light was made incident to the optical film in parallel to the transmission axis of the polarizing plate side of the optical film to measure the absorbance A (420) of the optical film at a wavelength of 420 nm in the transmission direction of the polarizing plate and the absorbance A (450) of the optical film at a wavelength of 450 nm in the transmission direction of the polarizing plate. The results are shown in Table 4. The optical film 1 exhibited all the characteristics represented by the formulae (1), (2) and the formulae (6) to (8).

A(420)≧1 (1)

A(450)/A(420)≦0.3 (2)

Re(450)/Re(550)≦1 (6)

1≦Re(630)/Re(550) (7)

100 nm≦Re(550)≦170 nm (8)

### Examples 16 to 28 and Comparative Examples 5 to 8

Each optical film (circularly polarized plate) to which an optically anisotropic layer was transferred in the same manner as in Example 15 was prepared using the pressure-sensitive adhesive composition described in the following Table 4. The optical characteristics of the obtained optical film (circularly polarizing plate) were measured in the same method as in Example 15.

TABLE 4

| | | Optical characteristics of optical film | | | | | |
|---|---|---|---|---|---|---|---|
| | Pressure- | (circularly polarizing plate) | | | | | |
| | sensitive | | | A | | | |
| | adhesive | A | A | (450)/A | Re | Re | Re |
| | sheet | (420) | (450) | (420) | (450) | (550) | (630) |
| Example 15 | Production | 3.1 | 0.22 | 0.071 | 125 | 136 | 138 |
| | Example 1 | | | | | | |
| Example 16 | Production | 3.1 | 0.21 | 0.069 | 125 | 137 | 139 |
| | Example 2 | | | | | | |
| Example 17 | Production | 3.1 | 0.20 | 0.064 | 126 | 137 | 139 |
| | Example 3 | | | | | | |
| Example 18 | Production | 3.1 | 0.20 | 0.063 | 123 | 134 | 136 |
| | Example 4 | | | | | | |
| Example 19 | Production | 3.2 | 0.21 | 0.066 | 128 | 139 | 141 |
| | Example 5 | | | | | | |
| Example 20 | Production | 3.0 | 0.21 | 0.069 | 123 | 135 | 137 |
| | Example 6 | | | | | | |
| Example 21 | Production | 3.1 | 0.20 | 0.064 | 125 | 138 | 139 |
| | Example 7 | | | | | | |
| Example 22 | Production | 3.0 | 0.21 | 0.070 | 126 | 138 | 140 |
| | Example 8 | | | | | | |
| Example 23 | Production | 3.1 | 0.21 | 0.068 | 126 | 137 | 139 |
| | Example 9 | | | | | | |
| Example 24 | Production | 3.1 | 0.20 | 0.065 | 126 | 138 | 140 |
| | Example 10 | | | | | | |
| Example 25 | Production | 3.2 | 0.21 | 0.066 | 126 | 138 | 140 |
| | Example 11 | | | | | | |
| Example 26 | Production | 3.0 | 0.21 | 0.070 | 125 | 136 | 139 |
| | Example 12 | | | | | | |
| Example 27 | Production | 3.0 | 0.22 | 0.073 | 126 | 138 | 140 |
| | Example 13 | | | | | | |
| Example 28 | Production | 3.1 | 0.22 | 0.071 | 126 | 137 | 139 |
| | Example 14 | | | | | | |
| Comparative | Production | 0.87 | 0.19 | 0.215 | 127 | 138 | 140 |
| Example 5 | Example 15 | | | | | | |
| Comparative | Production | 0.88 | 0.21 | 0.239 | 128 | 139 | 140 |
| Example 6 | Example 16 | | | | | | |
| Comparative | Production | 0.17 | 0.12 | 0.695 | 126 | 137 | 139 |
| Example 7 | Example 17 | | | | | | |
| Comparative | Production | 0.16 | 0.12 | 0.750 | 128 | 139 | 141 |
| Example 8 | Example 18 | | | | | | |

The optical films of Examples 15 to 28 had high absorption of light having a wavelength of 420 nm, whereas they had no absorption of light having a wavelength of 450 nm and when they were each mounted on a display device, no deterioration in display performance was observed. It was also confirmed that each optical film satisfied the performance required for a circularly polarizing plate. On the other hand, the optical films of Comparative Examples 5 to 8 had low absorption of light having a wavelength of 420 nm and were also increased in the value of A(450)/A(420) and it was therefore clarified that they had insufficient blue-light cutting function.

1. An optical film satisfying the formulae (1) and (2):
A(420)≧1 (1)
A(450)/A(420)≦0.3 (2)
wherein A(420) represents an absorbance of the optical film at a wavelength of 420 nm and A(450) represents an absorbance of the optical film at a wavelength of 450 nm.

2. The optical film according to claim 1, comprising at least one pressure-sensitive adhesive layer.

3. The optical film according to claim 1, wherein the at least one pressure-sensitive adhesive layer exists in an interior structure of the optical film or exists on an outermost surface of the optical film.

4. The optical film according to claim 3, wherein the at least one pressure-sensitive adhesive layer includes a pressure-sensitive adhesive composition containing:
(A) an acrylic resin;
(B) a crosslinking agent; and
(C) a light-selective absorption compound satisfying the formula (3):
ε(450)/ε(420)≦0.3 (3)
wherein ε(450) represents a gram absorption coefficient at a wavelength of 450 nm and ε(420) represents a gram absorption coefficient at a wavelength of 420 nm.

5. The optical film according to claim 4, wherein the pressure-sensitive adhesive composition contains:
(A) an acrylic resin which has a weight average molecular weight of 500000 to 2000000 and is a copolymer containing, as structural components:
(A-1) 50 to 99.9% by mass of a (meth)acrylate monomer represented by the formula (A-1): 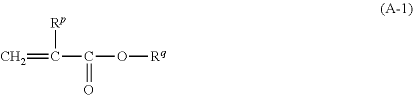
wherein R^{p} represents a hydrogen atom or a methyl group, R^{q} represents an alkyl group having 1 to 20 carbon atoms or an aralkyl group in which hydrogen atoms constituting the alkyl group or the aralkyl group are optionally substituted with —O—(C₂H₄O)ₙ—R^{r} in which n represents an integer from 0 to 4 and R^{r} represents an alkyl group having 1 to 12 carbon atoms or an aryl group having 1 to 12 carbon atoms; and
(A-2) 0.1 to 50% by mass of an unsaturated monomer having a polar functional group, based on the total solid content of the acrylic resin; and
(B) 0.01 to 10 parts by mass of a crosslinking agent based on 100 parts by mass of the acrylic resin.

6. The optical film according to claim 5, the optical film comprising 0.01 to 10 parts by mass of the light-selective absorption compound based on 100 parts by mass of the acrylic resin.

7. The optical film according to claim 1, comprising a light-selective absorption compound satisfying the formulae (3), (4), and (5):
ε(450)/ε(420)≦0.3 (3)
λmax≦430 nm (4)
ε(420)≧20 (5)
wherein ε(450) represents a gram absorption coefficient at a wavelength of 450 nm, ε(420) represents a gram absorption coefficient at a wavelength of 420 nm, and λmax represents the maximum absorption wavelength of the light-selective absorption compound.

8. The optical film according to claim 4, wherein the light-selective absorption compound is a compound selected from the group consisting of a compound having a dimethine skeleton, an azo compound, and a compound having a pyrazolone skeleton.

9. The optical film according to claim 4, wherein the light-selective absorption compound is a compound having a dimethine skeleton with at least one electron-attracting group on one side thereof and at least one electron-donating group on the other side thereof.

10. The optical film according to claim 4, wherein
the light-selective absorption compound includes at least one compound selected from the group consisting of;
a compound represented by the formula (I): 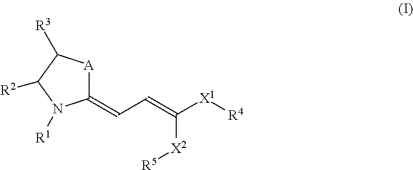
wherein R¹ represents a hydrogen atom or an alkyl group having 1 to 10 carbon atoms, wherein when the alkyl group has at least one methylene group, at least one methylene group is optionally substituted with an oxygen atom or a sulfur atom; R² and R³ each independently represent a hydrogen atom or an alkyl group having 1 to 12 carbon atoms; R⁴ and R⁵ each independently represent an alkyl group having 1 to 50 carbon atoms or an alkyl group having 3 to 50 carbon atoms and at least one methylene group, in which at least one methylene group is substituted with an oxygen atom, a carbon atom on the alkyl group is optionally bonded with a substituent, and R⁴ and R⁵ may be combined to form a ring structure, wherein when the ring structure formed by R⁴ and R⁵ has at least one methylene group, at least one methylene group is optionally substituted with —CO—, —NR⁶—, —NCH₂COOR⁶⁻¹—, —O—, —CS—, or —COO—, wherein R⁶ and R⁶⁻¹ each independently represent an alkyl group having 1 to 12 carbon atoms;
wherein A represents a methylene group, a secondary amino group, an oxygen atom, or a sulfur atom; and
wherein X¹ and X² each independently represent —CO—, —COO—, —OCO—, —O—, —S—, —NR⁷—, —NR⁸CO—, or —CONR⁹—, wherein R⁷, R⁸, and R⁹ each independently represent a hydrogen atom, an alkyl group having 1 to 6 carbon atoms, or a phenyl group;
a compound represented by the formula (II): 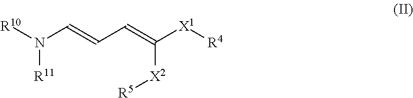
wherein R¹⁰ and R¹¹ each independently represent an alkyl group having 1 to 12 carbon atoms, an aralkyl group, an aryl group, or a heterocyclic group, wherein when the alkyl group has at least one methylene group, at least one methylene group is optionally substituted with an oxygen atom or a sulfur atom, the aralkyl group, the aryl group, and the heterocyclic group each optionally have a substituent, and R¹⁰ and R¹¹ may be combined to form a ring structure; and
wherein R⁴, R⁵, X¹, and X² have the same meanings as those in the formula (I); and
a compound represented by the formula (III): 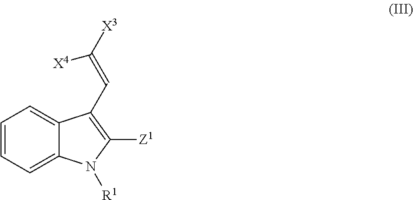
wherein Z¹ represents a hydrogen atom, an alkyl group having 1 to 10 carbon atoms, an aralkyl group, an aryl group, or a heterocyclic group, wherein when the alkyl group has at least one methylene group, at least one methylene group is optionally substituted with a secondary amino group, an oxygen atom, or a sulfur atom, and the aralkyl group, the aryl group, and the heterocyclic group each optionally have a substituent and X³ and X⁴ each independently represent an electron-attracting group; and
wherein R¹ has the same meaning as that in the formula (I).

11. The optical film according to claim 10, wherein X¹ and X² in the formulae (I) and (II) are each independently selected from —CO—, —COO—, and —CONR⁹—.

12. The optical film according to claim 10, wherein, in the formula (I), R² and R³ are each independently a hydrogen atom, and A is a methylene group or a sulfur atom.

13. The optical film according to claim 10, wherein in the compound represented by the formula (II), R¹⁰ and R¹¹ are each independently an alkyl group having 1 to 10 carbon atoms or a compound represented by the formula (II-1): 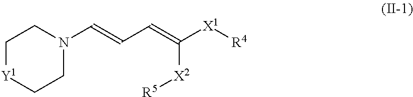
wherein Y¹ represents a methylene group or an oxygen atom; and
wherein R⁴, R⁵, X¹, and X² have the same meanings as those in the formula (I).

14. The optical film according to claim 1, further comprising at least one polarizing plate satisfying the formulae (1-1) and (2-1):
Ap(420)≧1 (1-1)
Ap(450)/Ap(420)≦0.3 (2-1)
wherein Ap(420) represents an absorbance of the optical film at a wavelength of 420 nm in a transmission direction of the at least one polarizing plate and Ap(450) represents an absorbance of the optical film at a wavelength of 450 nm in the transmission direction of the at least one polarizing plate.

15. The optical film according to claim 1, comprising at least one retardation film.

16. A display device comprising the optical film as claimed in claim 1.
